(19) United States
(12) Patent Application Publication
(10) Pub. No.: US 2017/0321454 A1
(43) Pub. Date: Nov. 9, 2017

(54) Gravity Gate Latch

(71) Applicant: Joshua Steven Siebert, Fresno, CA (US)

(72) Inventor: Joshua Steven Siebert, Fresno, CA (US)

(21) Appl. No.: 15/431,064

(22) Filed: Feb. 13, 2017

Related U.S. Application Data
(63) Continuation-in-part of application No. 15/145,349, filed on May 3, 2016.

(51) Int. Cl. E05B 65/00; E05B 67/38; E05C 1/06; E05C 19/10

(52) U.S. Cl. CPC E05B 65/0007; E05C 19/10; E05B 67/383; E05C 1/06

(57) ABSTRACT

A gravity gate latch that is positioned near the free end of a gate to automatically engage a strike member. The gate latch has a pair of side plates that are spaced apart to define to enclose a hook plate and a sliding mechanism. The hook plate has a hook member that engages the strike member of the gate and a slot that engages the sliding mechanism to allow the hook plate to move upward and downward between the two side plates. The side plates define an enlarged latch mouth that receives the strike member. The hook member has an elongated edge to be hit by the strike member to lift the hook plate to allow the strike member to pass through the latch mouth and an enlarged area that is hit by the strike member to close the hook member to trap the strike member in the gate latch.

### CROSS-REFERENCE TO RELATED APPLICATIONS

This patent application is a continuation-in-part of U.S. patent application Ser. No. 15/145,349 filed May 3, 2016.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

### A. Field of the Invention

The field of the present invention relates generally to gravity-type gate latches that are utilized to control ingress and egress into an area that is accessed through a gate that laterally pivots relative to an upright gate post having a strike member which is releasably engaged by the gate latch. In particular, the present invention relates to such gravity gate latches that easily and effectively engages the strike member. Even more particularly, the present invention relates to such gravity gate latches that are also configured to more effectively engage the strike member when the gate is slammed shut.

### B. Background

Fences or similar structures are frequently utilized to enclose an area by defining a border around the area that at least generally prevents unauthorized ingress into and egress from the area. To allow persons, animals, equipment and materials to pass into or out of the enclosed area, most fences include a gate that is sized and configured to allow such passage. With regard to homes, offices and the like that have a yard or other enclosed area, which is typically a back yard, the gate is usually located on one side of the building and pivotally mounted at one end to a gate post so that the gate can swing laterally relative to the gate post to which the gate is mounted. To prevent uncontrolled entry into or exit from the enclosed area through the gate, most gate systems utilize a gate latch that engages either the gate itself or a device attached to the gate, such as a strike or the like, to place the gate in its closed position. Disengaging the gate latch from the gate or the device attached to the gate allows the gate to be moved to its open position for entering or exiting the enclosed area. Such gate latches are usually mounted to a fixed object so as to be in an opposite facing relationship with the end of the gate having the device, or which is otherwise engaged by the gate latch, that is opposite the end which is pivotally attached to the gate post. Although the fixed object can be the side of the building, most often the gate latch is mounted to a separate post that is attached to the building or mounted in the ground near a side of the building and positioned in spaced apart relation to the gate post.

To allow a person or persons to control or limit access to the enclosed area through the gate, most gate latches are configured to be placed in a locked condition and an unlocked condition. Some gate latches have a built-in or an integrally incorporated locking mechanism that is operated to lock or unlock the gate. The typical gate latch, specially those utilized by homeowners and the like to control ingress and egress through the gate to a back yard, does not have such a locking mechanism. Instead, most such gate latches are configured to be utilized with a separate lock, such as a padlock, that has a shackle which is sized and configured to be placed through an aperture in the gate latch. To place the gate latch in its locked condition, the shackle is inserted through the aperture in the gate latch with the lock portion of the padlock hanging generally below the gate latch (whether the shackle is engaged with and locked to the lock or not). With the shackle disposed through the aperture, the gate latch cannot be moved to its unlocked position and the gate cannot be opened. To open the gate for entry or exit from the enclosed area, the gate latch is moved to its unlocked position by removing the shackle of the padlock from the gate latch (after unlocking the padlock, if necessary) and operating the gate latch to disengage it from the gate or the device attached to the gate. The configuration and use of such gate latches are well known by persons skilled in the relevant art.

A very common type of a gate latch that is utilized with a post mounted pivoting gate is the type that is referred to as a gravity gate latch. A gravity gate latch is generally mounted on a post, herein referred to as the latch post, that is positioned opposite the free swinging end of the gate (i.e., the end of the gate opposite the end pivotally mounted to the gate post) and is configured to engage a strike member that is attached to the free end of the gate when the free end of the gate is adjacent to the gate latch. The standard gravity gate latch has a plate that attaches to the latch post, a bracket that extends perpendicularly from the plate to define a mouth-like opening in which a hook member is allowed to pivot up and down to engage or be disengaged from the strike member attached to the free end of the gate. The gravity gate latch is configured such that when the strike member hits the hook member it causes the hook member to lift upward and allow the strike member inside the mouth area of the bracket. The hook member then falls down, by force of gravity, to trap the strike member inside the mouth area of the bracket to secure the gate in its closed position. A shackle of a padlock is inserted through an aperture in either the hook member (typically) or the bracket to place the gravity gate latch in its locked condition. To open the gate, the shackle of the padlock is removed from the gravity gate latch and the hook member is lifted upward, usually by pushing rearward (toward the latch post) on the hook member to open the mouth area and allow the strike member to be removed therefrom and the gate swung away from the gravity gate latch.

While the locking and unlocking operation of a gravity gate latch is relatively easy from the side of the gate where the gravity gate latch is located, typically inside the enclosed area, most people do not find it easy to lock and unlock the gravity gate latch from the opposite side (i.e., typically outside the enclosed area) of the gate. As well known to persons who utilize gravity gate latches for egress and ingress through a gate, there are many circumstances when a person will be standing on the “wrong” side of the gate to lock/unlock the padlock and operate the gravity gate latch. In standard fence/gate configurations, the gravity gate latch and padlock cannot be easily reached from outside of the gate. Most fences and gates are too high for a person to reach over and manipulate the padlock, whether with a key or a by entering a combination, and operate the gravity gate latch to open the gate. Often, the person wanting to pass through the gate from outside the gate must walk around through the building to access the gravity gate latch from inside the enclosed area. To avoid this problem, many people use a string, cord, wire or other elongated member that passes through a hole from outside the gate to connect to the hook member so he or she may pull on the elongated member to pull on the hook member and allow the strike member to move out of the mouth area of the bracket. Unfortunately, it is relatively easy for these elongated members to become entangled, broken or otherwise useless. In addition, if the padlock is in the gravity gate latch, the elongated member will not be able to be utilized to open the gate.

Another common problem with utilizing gravity gate latches is that they generally have a very low tolerance for the strike member being out of the proper position, which is to be received in the mouth area of the latch. Unfortunately, many gates, particularly wooden gates having wooden posts, tend to sag or shift over time. When they do, the strike member may no longer be aligned with the mouth area of the gravity gate latch such that the strike member will not properly hit the hook member to cause it to raise upward and allow the strike member into the mouth area of the bracket. In any such circumstances, the strike member will hit against and, typically, just rebound off of either the gravity gate latch or the latch post, which will prevent the gate from being placed in its closed position. Once the strike member is out of alignment due to movement of the gate, the gate either must be adjusted or the gravity gate latch must be moved on the latch post to realign the strike member with the hook member.

Yet another problem with many gravity gate latches is that they have issues with the gate latch engaging the strike member when the gate is slammed shut. As well known in the art, when the gate is slammed or otherwise forcibly shut the strike member may hit against the back portion of the mouth are and bounce out before the hook member has a chance to fall in front of the strike member in order to trap the strike member inside the mouth area so the gate latch may engage the strike member and latch the gate. Unfortunately, a person who slams the gate shut may be moving away from the gate in such a manner that he or she will not realize the strike member was not engaged by the gate latch and, therefore, the gate remains is not locked. As will be readily appreciated by persons skilled in the art, fixing the above-described alignment problem by increasing the tolerance for the strike member is likely to exacerbate the problem with the hook member of the gate latch not falling fast enough. p Another problem with the existing gravity gate latches is that there is no place to conveniently place the padlock when the padlock is removed from the gravity gate latch. Generally, the person removing the padlock from the gravity gate latch will place the padlock on the ground, hang it from the gate or fence, place it in their pocket or just carry it around. As well known to persons who use such gate latches and padlocks, often this results in the person forgetting where he or she placed the padlock or the padlock being placed down somewhere and the person having to look for it.

Despite the general ease of operation and other general advantages of gravity gate latches, the above-described problems limit the effectiveness and ease of use of these gate latches. What is needed, therefore, is an improved gravity gate latch that can be utilized with a gate to automatically secure the gate in a closed position and to allow a person to move the gate to its open position that solves the problems identified above. More specifically, what is needed is an improved gravity gate latch that quickly, easily and more effectively engages a strike member even when a gate that is associated with the gate latch is slammed or otherwise forcibly shut. Preferably, in one embodiment, the gravity gate latch will be structured and arranged to be attached to a fixed object, such as the side of a building or on a post, and be able to releasably engage a strike member that is mounted on the free end of a gate which pivots relative to a gate post or the like. The new gravity gate latch should be configured to provide improved tolerance for gates that sag or otherwise shift position. In its preferred configurations, the new gravity gate latch should be relatively inexpensive to manufacture.

### SUMMARY OF THE INVENTION

The gravity gate latch of the present invention provides the benefits and solves the problems identified above. That is to say, the gravity gate latch of the present invention is configured to be utilized with a gate which laterally pivots relative to a gate post so as to automatically secure the gate in a closed position and to easily and conveniently allow a person to move the gate to its open position. More specifically, the gravity gate latch of the present invention that quickly, easily and more effectively engages a strike member even when a gate that is associated with the gate latch is slammed or otherwise forcibly shut. In one configuration, the gravity gate latch of the present invention is structured and arranged to be attached to a side of a building or onto a post and releasably engage a strike member that is mounted on the free end of a laterally swinging gate. In some configurations, the new gravity gate latch may be attached to the free end of the gate to engage a strike member attached to the building or post. The new gravity gate latch of the present invention is structured and arranged to provide more tolerance for gates that sag or otherwise shift position. In a preferred configuration, the new gravity gate latch is relatively inexpensive to manufacture.

The gravity gate latch of the present invention allows the user to securely and automatically latch a gate, such as a wooden gate. The mounting location of the gravity gate latch between the stationary or fixed latch post and the free end of the gate allows the user to latch, unlatch, lock and unlock the new gate latch from both sides of the gate (i.e., inside and outside relative to the enclosed area). The new gravity gate latch can be utilized on single gates and double gates. In one embodiment, the gravity gate latch has outwardly extending lever arms on both sides of the latch, which correspond to both sides of the gate, that project beyond both sides of the gate to allow easy opening of the new gate latch from either side of the gate. In this configuration, when the gate latch is utilized with a padlock, the gravity gate latch can be easily and conveniently locked and unlocked, by locking or unlocking the padlock, from both sides of the gate. The gravity gate latch of the above configuration has two operating options for disengaging the gate from the latch: (1) pushing down on a lever; and (2) pulling up on the hook bracket, which is the bracket that the hook is attached to or, preferably, integrally formed.

In one embodiment of the present invention, the new gravity gate latch generally comprises a first side plate, a second side plate, a hook plate, a lever actuating mechanism and a lock receiving member. The second side plate is securely attached to the first side plate. Each of the side plates are configured to define a latch mouth at a first side of the gate latch. The latch mouth is sized and configured to receive a strike member that is attached to or integral with the first end of the gate when the gate is in its closed condition. A plurality of spacers are disposed between the first side plate and the second side plate to position the second side plate in spaced apart relation to the first side plate and define a space between the two plates. The hook plate, which is moveably disposed in the space between the two plates, has a hook member that is attached to or integral with the hook plate. The hook plate positions the hook member in the latch mouth so it can be contacted by the strike member when the gate is moved to its closed position.

The lever actuating mechanism is operatively disposed in the space between the two plates and configured to move the gate latch between a latched condition with the hook member in the latch mouth and an unlatched condition with the hook member generally above the latch mouth. In a preferred configuration, the lever actuating mechanism has a first lever arm, a second lever arm, a guide spacer and a latch hook. Each lever arm is pivotally connected to at least one of the two side plates so as to pivot a second end of one of the lever arms upward when a first end of the lever arm is pressed downward by a person wanting to unlatch the gate latch. The second end of each lever arm is positioned in the space to engage the hook plate and raise the hook plate upward to move the hook member sufficiently above the latch mouth to allow the strike member to move out of the latch mouth when the gate latch is in the latched condition. The guide spacer is attached to one of the two side plates. The latch hook is attached to or integral with the hook plate and sized and configured to be guided upward and downward by the guide spacer when one of the lever arms pivots the hook plate upward. The lock receiving member is attached to the latch hook generally below the lower ends of the two side plates when the gate latch is in the latched condition. The lock receiving member has an aperture that is sized and configured to receive a shackle of a padlock to place the gate latch in a locked condition, which prevents upward movement of the hook plate and placement of the gate latch in an unlatched condition.

The gate latch is sized and configured to be positioned in a gap between the first end of the gate and the stationary object with the first and second sides of the gate latch being disposed on opposite sides of the gate (i.e., generally toward opposite areas separated by the gate) so as to receive the strike member in the latch mouth to place the gate latch in the latched condition. The user raises the hook plate to unlatch the gate by pressing down on one of the lever arms to place the gate latch in an unlatched condition. The gate latch also disposes the padlock in the gap between the first end of the gate and the stationary object to allow a user to access the padlock from either side of the gate. A new gate system includes the gate, stationary object, gap between the gate and stationary object, strike member on the gate and the above-described latch.

With regard to the present invention, the new gravity gate latch generally comprises a first side plate, a second side plate attached to the first side plate in spaced apart relation thereto so as to define a space therebetween, a hook plate moveably disposed in the space between the first side plate and the second side plate, and a sliding mechanism associated with the first side plate, the second side plate and the hook plate and disposed in the space between the first and second side plates. Each of the side plates are configured to define a latch mouth at a first side of the gate latch, with the latch mouth being sized and configured to receive a strike member that is attached to or integral with a first end of a gate when the gate is in a closed condition. The hook plate has a hook member that is attached thereto or integral therewith. The hook plate is configured to dispose the hook member in the latch mouth so as it will be contacted by the strike member when the gate is moved to the closed position. The sliding mechanism is structured and arranged to allow the gate latch to move between a latched condition with the hook member positioned in the latch mouth substantially closing the latch mouth and an unlatched condition with the hook member positioned sufficiently above the latch mouth to allow the strike member to move out of or into the latch mouth. One or more spacers are utilized to space the two side plates in spaced apart relation to each other. The new gate latch is sized and configured to be attached to a stationary object with the first side of the gate latch positioned to receive the strike member in the hook slot behind the latch mouth to trap the strike member therein by the hook member in order to place the gate latch in the latched condition and to raise the hook plate in order to place the gate latch in an unlatched condition. In a preferred configuration, the new gate latch has a pull plate that is attached to or integral with the hook plate so as to extend above an upper end of each of the side plates, with the pull plate being sized and configured to be pulled upward to pull the hook plate and hook member upward so as to move the gate latch from the latched condition to the unlatched condition.

The new gate latch has a lock receiving aperture in the hook member that is sized and configured to receive a shackle of a padlock. The lock receiving aperture is positioned so as to place the gate latch in a locked condition that prevents upward movement of the hook plate which would be otherwise sufficient to move the hook member to the unlatched condition, thereby securing the gate latch in the latched condition. At least one of the side plates has an outward extending arm that is positioned generally above the lock receiving aperture when the gate latch is in the locked condition, with the outward extending arm being structured and arranged to be engaged by the shackle of the padlock to prevent the gate latch from being placed in the unlatched condition. In a preferred configuration, each of the side plates have outwardly extending arms that are in spaced apart relation to each other and the hook member is sized and configured to move upwardly and downwardly between the two outwardly extending arms when moving between the latched condition and the unlatched condition.

In a preferred configuration, the hook member has an elongated edge disposed in the latch mouth that is positioned so as to be contacted by the strike member when the gate latch is engaged by the strike member to place the gate latch in the latched condition. A preferred embodiment of the gate latch also has the latch mouth provided with an enlarged latch mouth opening that is at least three times larger than the strike member diameter of the strike member. The elongated edge of the hook member and the enlarged latch mouth opening are provided to allow the gate latch to compensate for sagging or other improper gate positioning that would otherwise result in the latch mouth not being aligned with the strike member attached to the gate.

Preferably, the hook plate has an enlarged area with an angled edge, with the enlarged area being shaped and configured to be hit by the strike member and rapidly lower the hook plate to trap the strike member in the hook slot of the hook plate generally behind the latch mouth with the hook member in the latch mouth to place the gate latch in the latched condition. The enlarged area and angled edge thereof ensure that the gate latch will latch onto the strike member even in circumstances where the gate is slammed or otherwise forcibly shut, a circumstance that often results in the strike member “bouncing” out of prior art gate latches, which leaves the gate unlatched and unlocked (often unbeknownst to the person closing the gate). The enlarged area and angled edge at the back side of the hook slot prevent this problem by driving the hook plate down to trap the strike member in the hook slot behind the hook member.

The new gate latch has a padlock aperture in at least one of the first side plate and the second side plate. The padlock aperture is sized and configured to receive a shackle of a padlock without engaging the hook plate or the sliding mechanism so as to store the padlock on the gate latch without placing the gate latch in a locked condition. The hook member has a hook-shaped area that is sized and configured to engage a spacer which is disposed between the first side plate and the second side plate so as to prevent the hook plate from exiting above an upper end of each of the first side plate and the second side plate.

Accordingly, the primary object of the present invention is to provide a new gravity gate latch and gate system that has the advantages discussed above and which overcomes the various disadvantages and limitations that are associated with presently available gravity gate latches and gate systems.

It is an important object of the present invention to provide a new gravity gate latch that is positioned between the free end of a gate and a stationary object to securely and automatically engage the gate with the gate latch to place the gate in its closed position so the gate latch can be easily and conveniently accessed from either side of the gate to disengage the gate from the latch and to unlock or lock a padlock that is attached to the gate latch.

It is an important object of the present invention to provide a new gravity gate latch that is positioned between the free end of a gate and a stationary object to securely and automatically easily and more effectively engage the strike member of the gate with the gate latch to place the gate in its closed position even when the gate is slammed or otherwise forcibly shut.

An important aspect of the present invention is that it provides a new gravity gate latch that accomplishes the objectives set forth above and elsewhere in the present disclosure.

Another important aspect of the present invention is that it provides a new gravity gate latch that is utilized to automatically and securely place a gate in its closed position, with the gate latch being sized and configured to be attached to a stationary object opposite from a free end of the gate to engage a component of the gate, such as a strike member attached to or integral with the gate.

Another important aspect of the present invention is that it provides a new gravity gate latch that has an elongated latch mouth and hook member edge that provides greater tolerance with regard to receiving a strike member that is attached to or integral with gates that have a tendency to sag, shift or otherwise move due to wood swelling, disrepair or improper build.

Another important aspect of the present invention is that it provides a new gravity gate latch that easily and more effectively engages a strike member that is attached to a gate even when the gate is slammed or otherwise forcibly shut by more quickly driving the hook member downward to trap the strike member in the mouth of the new gate latch.

Another important aspect of the present invention is that it provides a new gravity gate latch that is structured and arranged to allow a person to easily and conveniently disengage a gate from the gate latch from either side of the gate without having to reach over the gate, go around to the other side of the gate or utilize a string, cord, wire or other elongated member.

Another important aspect of the present invention is that it provides a new gravity gate latch that is configured to be utilized with a padlock to place the gate in its locked condition, with the gate latch being structured and arranged to allow a person to easily and conveniently lock and unlock the padlock, and therefore the gate itself, from either side of the gate.

Another important aspect of the present invention is that it provides a new gate latch that is configured to be attached to a fixed object, such as a latch post or wall, opposite the free end of a swinging gate with a lever arm extending outwardly from each side of the gate latch that can be easily and conveniently accessed to disengage the gate from the gate latch.

Another important aspect of the present invention is that it provides a new gravity gate latch that has a center disposed pull plate that allows the user to pull upward on the hook that engages the gate, or a strike attached to the gate, to disengage the gate from the gate latch.

Another important aspect of the present invention is that it provides a new gravity gate latch that includes a padlock aperture that allows the user to store a padlock when not in use and to provide the illusion that the gate is locked even thought the padlock is not preventing the unlatching of the gate.

Yet another important aspect of the present invention is that it provides a new gravity gate latch that is relatively inexpensive to manufacture.

As will be explained in greater detail by reference to the attached figures and the description of the preferred embodiment which follows, the above and other objects and aspects are accomplished or provided by the present invention. As set forth herein and will be readily appreciated by those skilled in the art, the present invention resides in the novel features of form, construction, mode of operation and combination of processes presently described and understood by the claims. The description of the invention which follows is presented for purposes of illustrating one or more of the preferred embodiments of the present invention and is not intended to be exhaustive or limiting of the invention. The scope of the invention is only limited by the claims which follow after the discussion.

### BRIEF DESCRIPTION OF THE DRAWINGS

In the drawings which illustrate the preferred embodiments and the best modes presently contemplated for carrying out the present invention:

FIG. 1 is a back perspective view of a gate system having a gate and a gravity gate latch that is configured according a first embodiment of the present invention to secure the gate in its closed position;

FIG. 2 is a back perspective view of the gate system of FIG. 1 with the gate shown in its open position to better show the new gravity gate latch and the strike member that is receivedly engaged by the gate latch;

FIG. 3 is a front view of the gravity gate latch of FIG. 1 shown separate from the gate system;

FIG. 4 is a top view of the gravity gate latch of FIG. 3;

FIG. 5 is a left side view of the gravity gate latch of FIG. 3 shown in its engaged condition with the strike member being engaged by the hook member of the gate latch;

FIG. 6 is a left side view of the gravity gate latch of FIG. 5 shown with the pull plate lifted upward to place the gate latch in its disengaged condition;

FIG. 7 is a left side view of the gravity gate latch of FIG. 5 shown with the first or front lever raising the hook bracket upward to place the gate latch in its disengaged position;

FIG. 8 is a left side view of the gravity gate latch of FIG. 5 shown with the second or back lever raising the hook bracket upward to place the gate latch in its disengaged position;

FIG. 9 is a left side perspective view of the gravity gate latch of FIG. 5 shown without the strike member and in its unlocked position;

FIG. 10 is a left side perspective view of the gravity gate latch of FIG. 9 shown in its locked position with a padlock;

FIG. 11 is a partial exploded left side perspective view of the gravity gate latch of FIG. 9 shown with the first plate separate from the other components of the gate latch;

FIG. 12 is a left side view of the gravity gate latch of FIG. 11 shown without the first plate;

FIG. 13 is a left side perspective view of the gravity gate latch of FIG. 12 shown with the pull plate lifted upward to place the gate latch in its disengaged condition;

FIG. 14 is a left side perspective view of the gravity gate latch of FIG. 12 shown with the first or front lever raising the hook bracket upward to place the gate latch in its disengaged position;

FIG. 15 is a left side perspective view of the gravity gate latch of FIG. 121 shown with the second or back lever raising the hook bracket upward to place the gate latch in its disengaged position;

FIG. 16 is a back perspective view of a gate system having a gate and a gravity gate latch that is configured according to a second embodiment of the present invention to secure the gate in its closed position with a strike member shown engaged in the mouth of the gravity gate latch;

FIG. 17 is a left side perspective view of the gravity gate latch of FIG. 16 shown separate from the gate system and without the strike member; FIG. 18 is right side perspective view of the gravity gate latch of FIG.

17 shown with the strike member in the mouth of the gravity gate latch and with the pull plate lifted upward to place the gravity gate latch in its unlatched condition;

FIG. 19 is a right side perspective view of the gravity gate latch of FIG. 18 shown with the gravity gate latch in its latched condition; FIG. 20 is a left side view of the gravity gate latch of FIG. 18 shown with the gravity gate latch in its unlatched condition;

FIG. 21 is a left side view of the gravity gate latch of FIG. 20 shown with the gravity gate latch in its latched condition;

FIG. 22 is a left side perspective view of the gravity gate latch of FIG. 20 shown with the gravity gate latch in its unlatched condition with the first side plate shown separate to better illustrate the internal components of the new gravity gate latch;

FIG. 23 is a left side perspective view of the gravity gate latch of FIG. 22 shown with the gravity gate latch in its latched condition with the first side plate shown separate to better illustrate the internal components of the new gravity gate latch;

FIG. 24 is a left side view of the hook plate and second side plate of FIG. 23 shown with the gravity gate latch in its latched condition; and

FIG. 25 is a right side perspective view of the gravity gate latch of FIG. 19 shown with the gravity gate latch in its latched condition with the second side plate shown separate to better illustrate the internal components of the new gravity gate latch.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures are illustrative of several potential preferred embodiments and, therefore, are included to represent several different ways of configuring the present invention. Although specific components, materials, configurations and uses are illustrated, it should be understood that a number of variations to the components and to the configuration of those components described herein and shown in the accompanying figures can be made without changing the scope and function of the invention set forth herein. For instance, although the description and figures included herewith generally describe and show particular materials, shapes and configurations for the various components of the new gravity gate latch of the present invention, as well as the gate and gate system with which the gate latch can be utilized, those skilled in the art will readily appreciate that the present invention is not so limited. In addition, the exemplary embodiment of the present apparatus is shown and described herein with only those components that are required to disclose the present invention. As such, many of the necessary mechanical elements for attaching and using the present invention are not shown or necessarily described below, but which are well known to persons skilled in the relevant art. As will be readily appreciated by such persons, the various elements of the present invention that are described below may take on any form consistent with forms that are readily realized by a person of ordinary skill in the art having knowledge of gravity gate latches, gate systems and gates.

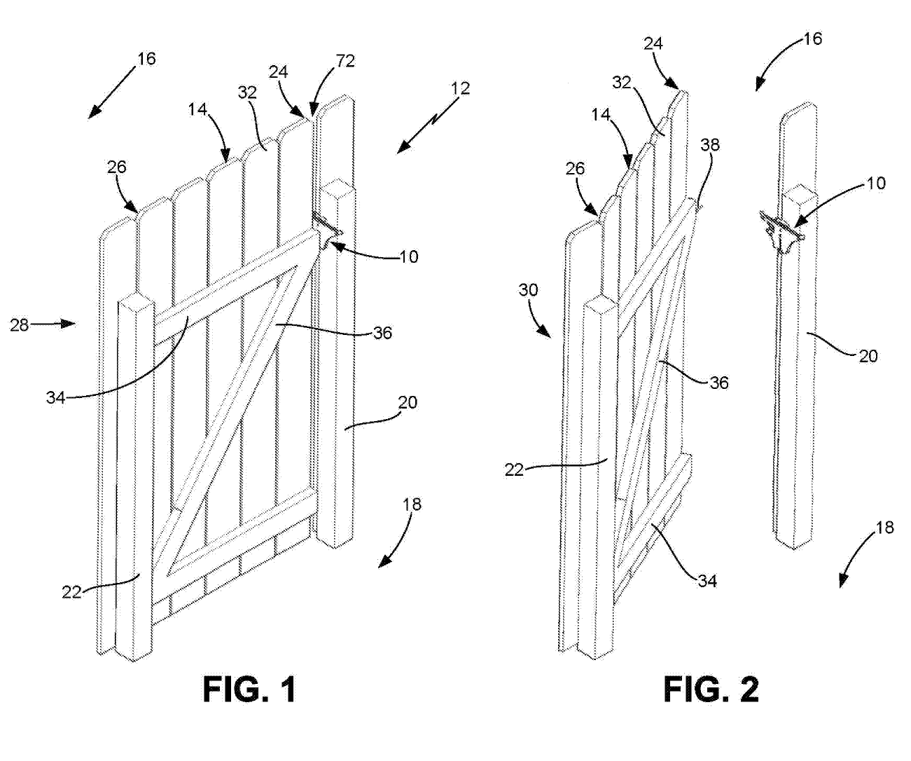

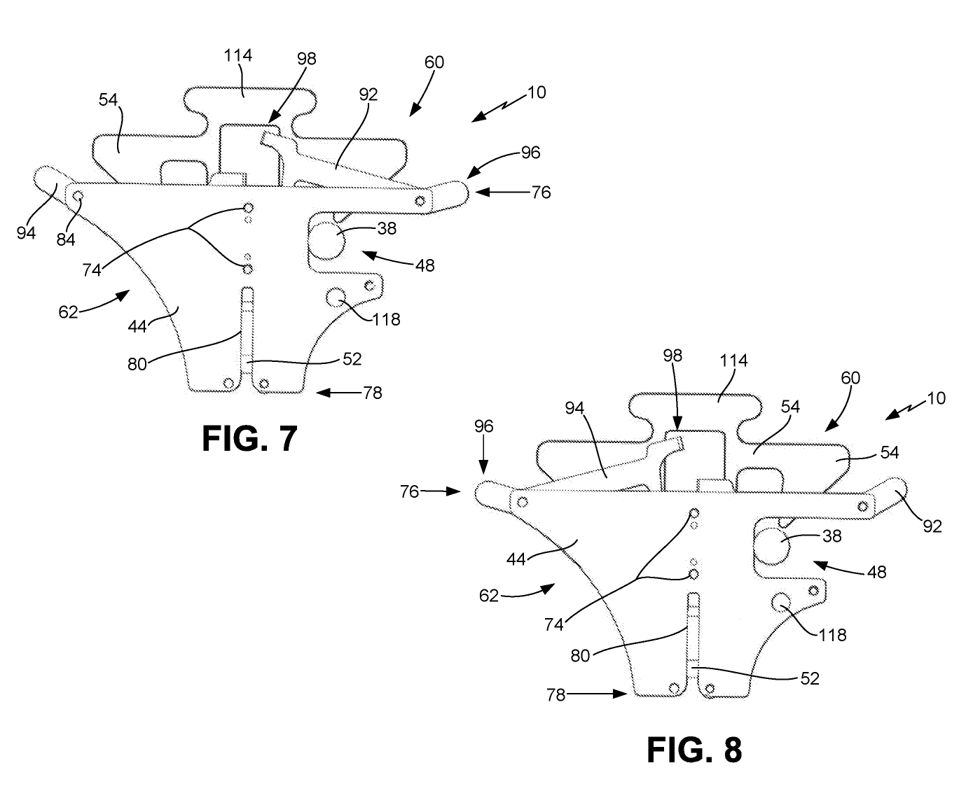

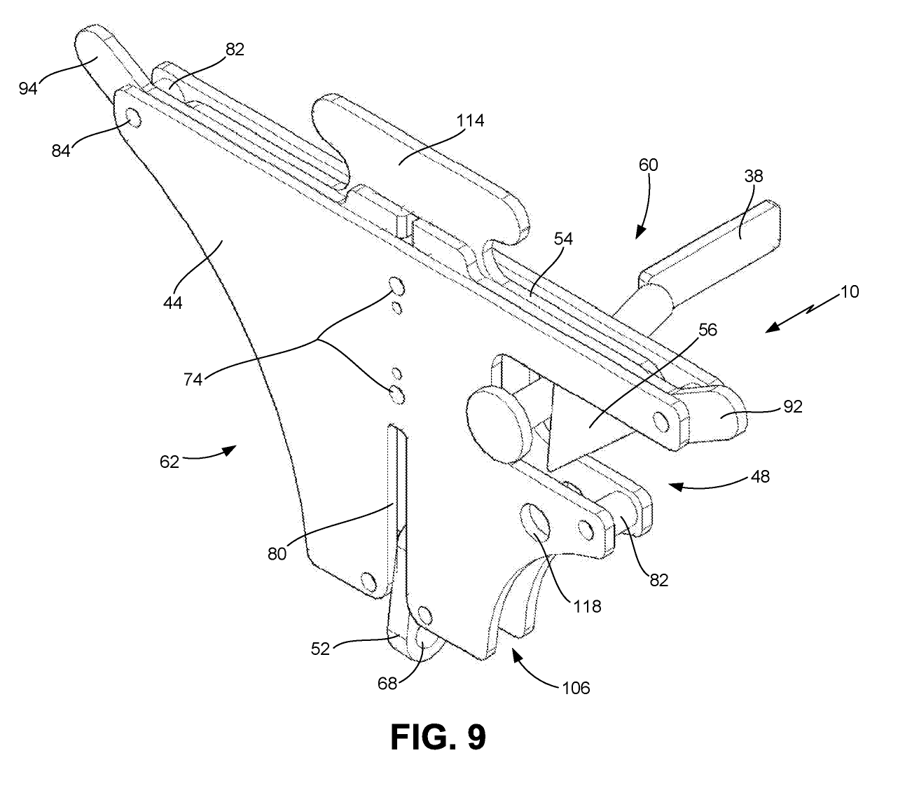

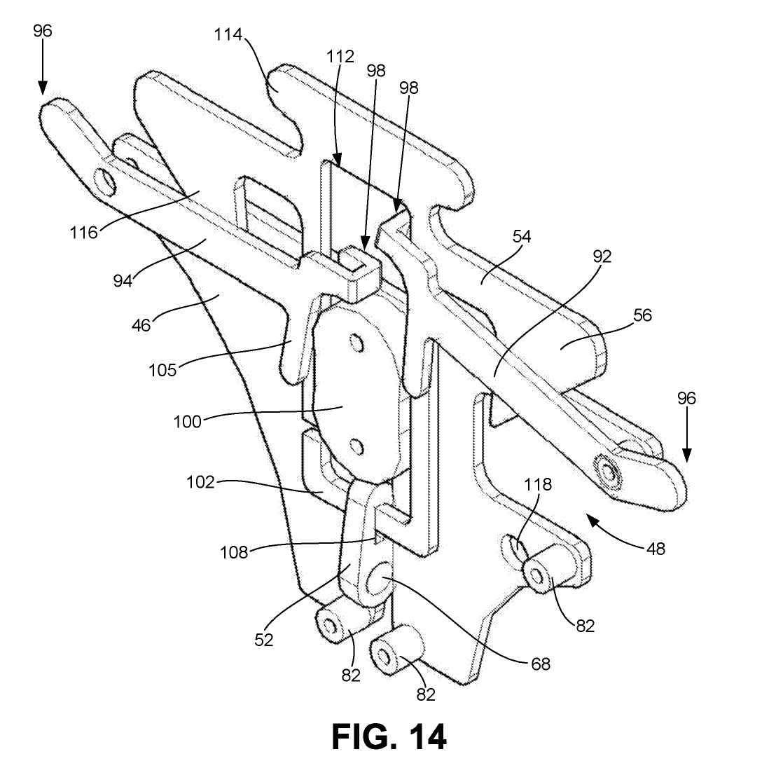

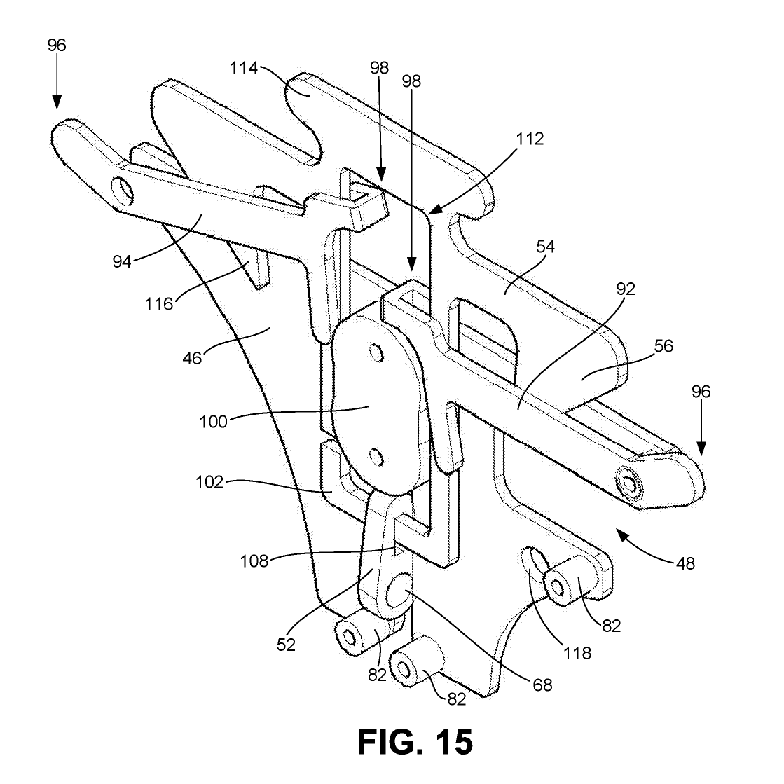

A gravity gate latch that is configured pursuant to one of the preferred embodiments of the present invention is referred to generally as 10 in FIGS. 1-15. The new gravity gate latch 10, herein referred to as the “gate latch”, is utilized with a gate system 12 having at least one gate 14 associated therewith, as shown in FIGS. 1 and 2. As will be readily appreciated by persons skilled in the art, the gate system 12 and gate 14 shown in FIGS. 1 and 2 are typical of gate systems and gates that are utilized with a fence (not shown), which is used to enclose an area (also not shown) to allow a person to enter into or exit from the enclosed area. For purposes of describing the present invention, the gate system 12 is configured for the gate to open outward to the outside or front area 16 and then swing back toward the enclosed or back area 18 (i.e., as if used to control entry or exit from the back yard of a house). The views of the gate latch 10 shown in the figures are referenced as from the front area 16 or the back area 18. As will be understood by those skilled in the art, the gate system 12 and the placement of the gate latch 10 of the present invention are not limited to the exemplary gate system 12 shown in FIGS. 1 and 2. For instance, the gate system 12 can be configured for the gate 14 to open in the opposite direction (i.e., towards the back area 18) instead of toward the front area 16, with the gate latch 10 of the present invention being positioned to engage the gate 14 or a component thereof, as set forth below.

In addition to the gate latch 10 and gate 14, the gate system 12 of FIGS. 1 and 2 comprises a first stationary or fixed object 20 to which the gate latch 10 is attached. For purposes of the present disclosure, the first stationary object 20 is a post that is, typically at least partially buried in the ground, concrete or other material or is attached to another stationary object (such as a wall) or part of the fence structure. The first stationary object 20 is referred to herein as a latch post (hereinafter identified as latch post 20). As well known in the art, however, the first stationary object can be a wall of a building, such as a house, or another object that is fixed in position to engage the gate 14. The gate 14 is hingedly attached to a second stationary or fixed object 22 so it can laterally swing relative thereto. For purposes of the present disclosure, the second stationary object 22 is also a post that is, typically at least partially buried in the ground, concrete or other material or is attached to another stationary object (such as a wall) or part of the fence structure. The second stationary object 22 is referred to herein as a gate post (hereinafter identified as gate post 20). As well known in the art, however, the second stationary object can be a wall of a building, such as a house, or another object that is fixed in position to hingedly (typically) support the gate 14. The gate 14 has a first or free end 24 and a second end 26, which is pivotally attached to the gate post 22, as shown in FIGS. 1 and 2. The gate 14 is positioned such that the first end 24 thereof is aligned with and opposite of the latch post 20 when the gate 14 is in its closed position 28, as shown in FIG. 1. When not engaged with the gate latch 10, the gate 14 is free to swing away from the gate latch 10 and latch post 20 to its open position 30, as shown in FIG. 2.

The gate 14, latch post 20 and gate post 22 shown in FIGS. 1 and 2 are made out of wood, having a plurality of vertical, generally upright positioned pickets 32, one or more horizontally disposed rail members 34 and one or more angled support members 36. As will be readily appreciated by persons skilled in the art, however, the gate 13 and posts 20/22 can be made out of a wide variety of materials, including steel, aluminum, fiberglass and the like, and in a wide variety of different configurations. As also well known, the gate latch 12 and gate 14 are cooperatively configured so the gate latch 12 will securely engage a component of the gate 14 or a device that is attached to the gate 14 to secure the gate 14 in its closed position 28, as shown in FIG. 1. In a typical gravity gate latch gate system, such as the gate system 12, a strike member 38 is attached to or integral with the first end 24 of the gate 14 so as to extend generally outwardly therefrom, as shown in FIG. 2. As described in more detail below, a portion of the strike member 38 is sized and configured to be engaged by the gate latch 10.

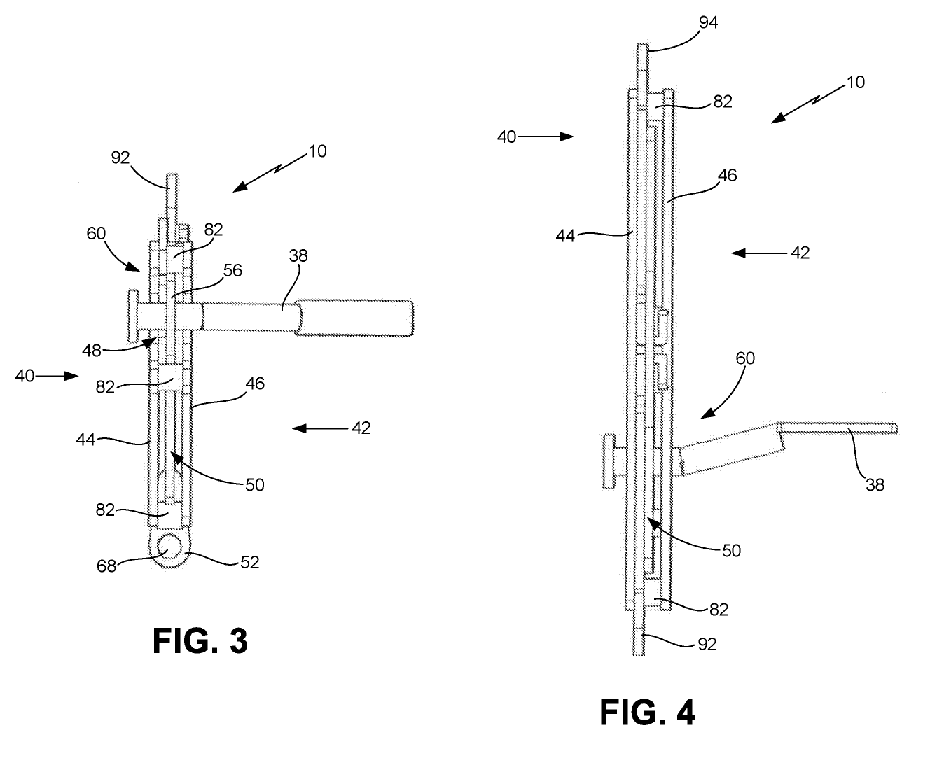

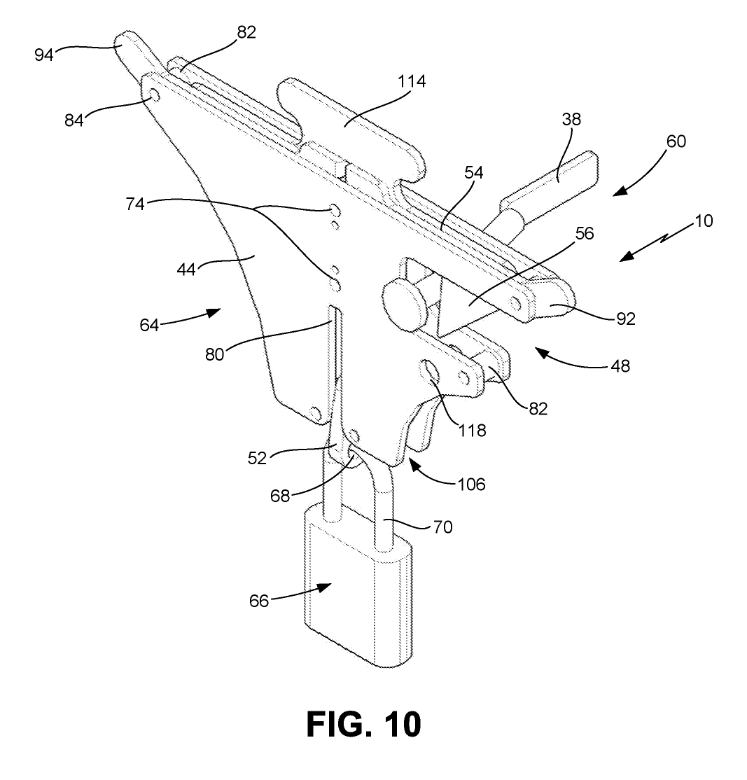

For purposes of describing the gate latch 10 of the present invention, the gate latch 10 has a first or post side 40 that is positioned, typically, in abutting relationship with the latch post 20 (first stationary object) and a second or gate side 42 that faces toward the first end 24 of the gate 14 when the gate 14 is in its closed position 28, as shown in FIG. 1. As will be described in more detail below, gate latch 10 generally comprises a first or post side plate 44, a second or gate side plate 46, a mouth 48 defined by the first plate 44 and second 46, a lever actuating mechanism 50 enclosed by the two plates 44/46, a lock receiving member 52 attached to or integral with the lever actuating mechanism 50 and a hook plate 54 that is moved by the lever actuating mechanism 50 to move a hook member 56 generally upward and downward, as best shown in FIGS. 3-15. When the hook member 56 is up, as shown in FIGS. 6-8 and 13-15, the gate latch 10 will be in its unlatched condition 58 and the strike member 38 will be able to move into or out of the mouth 48 (i.e., when moving from or to the open position 30 of gate 14). When the strike member 38 is in the mouth 48 and the hook member 56 is down, the hook member 56 traps the strike member 38 in the mouth 48 of the gate latch 10 to place the gate latch 10 in its latched condition 60 and, when the gate latch 10 is in use with the gate 14, place the gate 14 in its closed position 28, as best shown in FIGS. 1, 3-5, 10. Normally, the gate latch 10 is in an unlocked condition 62 that allows the lever actuating mechanism 50 to move the hook member 56 upward to receive the strike member 38 into the mouth 48 or to release the strike member 38 from the mouth 48. When the gate latch 10 is in its locked condition 64, the lever actuating mechanism 50 will be unable to move the hook member 56 upward and downward and, in typical use, the strike member 38 will be trapped in the mouth 48 of gate latch 10, as shown in FIG. 10. The lock receiving member 52 is structured and arranged to be engaged by a padlock 66 to place gate latch 10 in its locked condition 64. In a preferred configuration, the lock receiving member 52 has an aperture 68, best shown in FIGS. 4, 9-11 and 13-15, that is sized and configured to receive the shackle 70 of a padlock 66, as best shown in FIG. 10.

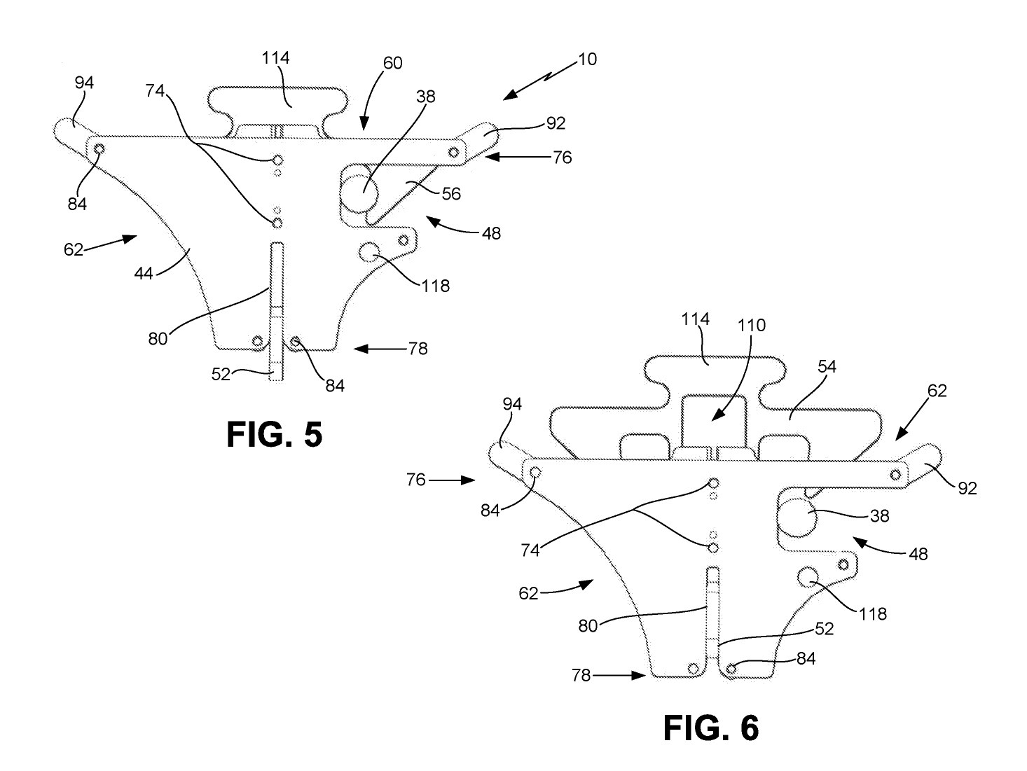

The gate latch 10 of the present invention is sized and configured to be attached to the latch post 20 and be positioned in a gap 72 between the first end 24 of the gate 14 and the latch post 20, as shown in FIGS. 1 and 2. In one embodiment, each of the first side plate 44 and second side plate 46 have one or more mounting holes 74, best shown in FIGS. 5-11, that are sized and configured to receive a connecting element (not shown), such as a screw, bolt, nail or the like, that is selected to secure the gate latch 10 to the latch post 20 (or other type of first stationary object). In the embodiment shown in the figures, each side plate 44/46 has two mounting holes 74. The mounting holes 74 on the first side plate 44 are aligned with the mounting holes 74 on the second side plate 46 so the connecting element can go through both side plates 44/46 and into latch post 20, or otherwise engage the first stationary object, to secure the gate latch 10 thereto. The side plates 44/46 have an upper end 76, above which the hook plate 54 moves as a result of the lever actuating mechanism 50 when the gate latch 10 moves to its unlatched condition 58. The side plates 44/46 also have a lower end 78 below which the lock receiving member 52 hangs when the gate latch 10 is in its latched condition 60. The lock receiving member 52 also hangs below the lower end 78 of the side plates 44/46 when the gate latch 10 is in its locked condition 64, as shown in FIG. 10. In the embodiment shown in the figures, each side plate 44/46 also has a slot 80 that is sized and configured to provide for free movement of the lock receiving member 52 as the gate latch 10 moves between its latched condition 60, with the receiving member 52 downwardly disposed, and its unlatched condition 62, with the receiving member 52 generally upwardly disposed in between the two side plates 44/46.

The two side plates 44/46, which are disposed in spaced apart relation to provide room for the lever actuating mechanism 50, lock receiving member 52 (when up) and hook plate 54, by a plurality of spacers 82, best shown in FIGS. 3-4 and 9-15. The two side plates 44/46 are joined together, with the spacers 82 between, utilizing a plurality of plate connectors 84, which may be rivets, screws, bolts or other devices, that are received through connector apertures 86 in the two side plates 44/46, as best shown in FIGS. 5-15. In addition to keeping the two side plates 44/46 in spaced apart relation, the spacers 82 at the lower end 78 of the side plates 44/46 also function as padlock stop members that prevent the shackle 70 of the padlock 66 from moving upward much beyond the lower end 78 of the side plates 44/46 in order to prevent the shackle 70 interfering with the lever actuating mechanism 50 disposed between the two side plates 44/46. As explained in more detail below, the two spacers 82 at or near the upper end 76 of the two side plates 44/46 are specially configured to allow components of the lever actuating mechanism 50 to pivot relative to the side plates 44/46 and, as a result, move the hook plate 54 up and down to move gate latch 10 between its latched condition 60 and unlatched condition 62.

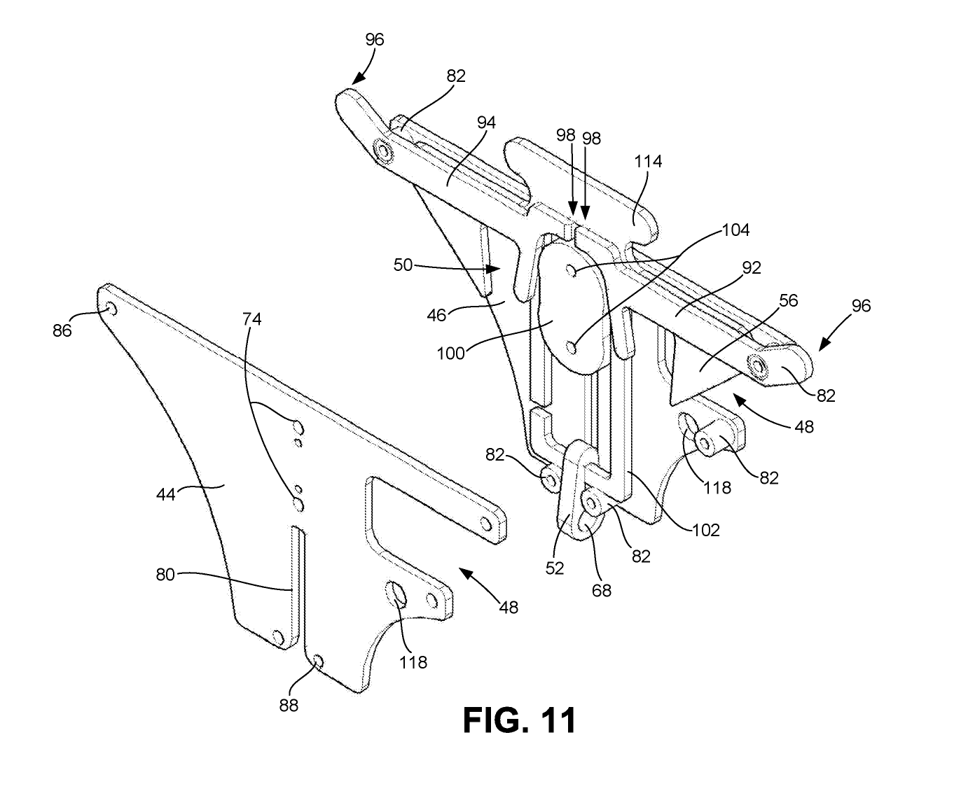

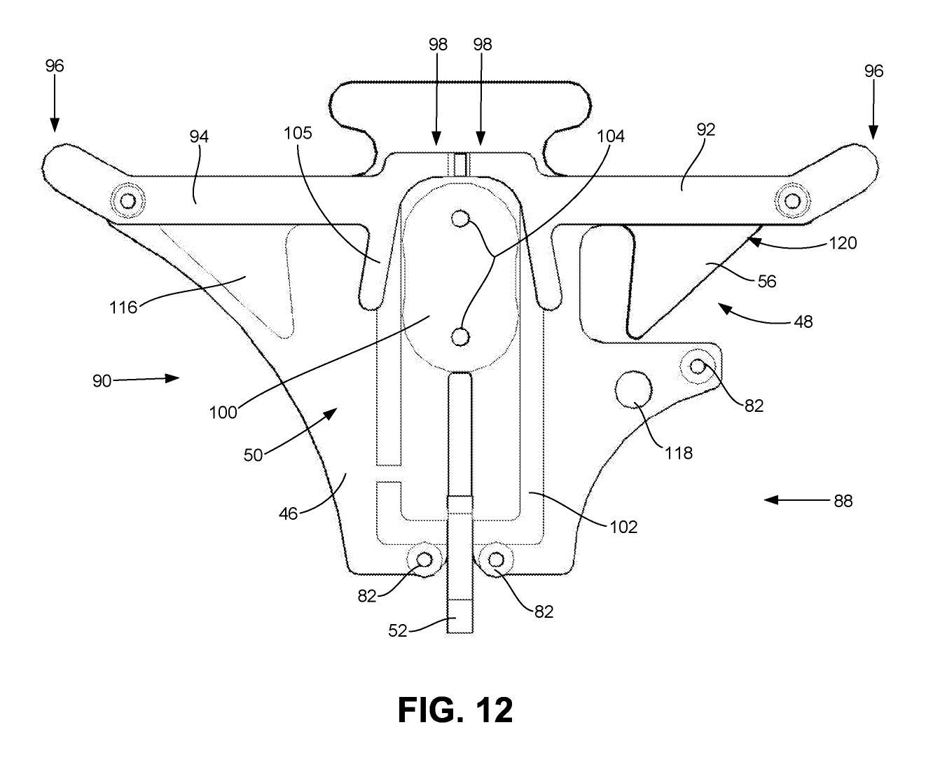

The lever actuating mechanism 50, which is best shown in the partial exploded views in FIGS. 11-15, is structured and arranged to allow the hook member 56 to automatically raise up when contacted from the first or front side 88 of the gate latch 10 (where the mouth 48 is located), by the strike member 38 as the gate 14 moves to its closed position 28 and to allow the user to manually place the gate latch 10 in its unlatched condition 58 when necessary or desired by the user. As best shown in FIG. 12, the gate latch 10 has a second or back side 90, which is directed in an opposite direction from first/front side 88 so as to be generally disposed in the direction of the back area 18 (shown in FIGS. 1 and 2). The lever actuating mechanism 50 generally comprises a pair of lever arms, shown as first or front lever arm 92 and second or back lever arm 94 (each of which have a first end 96 and a second end 98), a guide spacer 100 and a latch hook 102, as best shown in FIGS. 11 and 12. The configuration, function and operation of these components are set forth in detail below.

Each of the lever arms 92/94 are pivotally connected to the spacers 82 near the upper end 76 of the two slide plates 44/46 so as to pivot relative to the slide plates 44/46 and move the hook plate 54, and therefore the hook member 56 itself upward or downward. The second end 98 of the lever arms 92/94 pivot in an upward direction when the user presses downward on the first end 96 of either lever arm 92/94. This will place the gate latch 10 in its unlatched condition 58 so the user can move the hook member 56 out of the way of the strike member 38 to allow the user to disengage the gate latch 10 from the strike member 38. Once disengaged, the user can open the gate 14. Because there are two lever arms 92/94, one on the first/front side 88 and one on the second/back side 90, the user can unlatch the gate latch 10 from either the front area 16 or back area 18 by pressing down, respectively, on first lever arm 92 or the second lever arm 94. As such, the user will not have to reach over the gate 14, walk around to the opposite side of the gate 14 or utilize any string, cord, wire or other elongated member. The lever arms 92/94 will pivot in a downward direction due to gravity to place the gate latch 10 in its latched condition 60, when the strike member 38 is in the latch mouth 48, or to close the hook member 56 in the latch mouth 48 in preparation for contact with the strike member 38, when the strike member 38 is not in the latch mouth 48. As will be readily appreciated by persons who are skilled in the relevant art, the lever actuating mechanism 50 of the gate latch 10 is structured and arranged for easy and convenient latching and unlatching of the gate latch 10.

The guide spacer 100 is sized and configured to guide the movement of the hook plate 54 and the lever arms 92/94. In one embodiment, the guide spacer 100 is made out of plastic and mounted against the inside wall of the second or gate side plate 46, as best shown in FIGS. 11 and 12. The guide spacer 100 has a pair of mounting holes 104, best shown in FIGS. 11 and 12, that are in alignment with the mounting holes 74 of the side plates 44/46 so the connecting element that secures the gate latch 10 to the latch post 20 (or other first stationary object) can pass through the guide spacer 100. As best shown in FIG. 12, the guide spacer 100 is positioned generally in the upper half (i.e., toward the upper end 76) of the second side plate 46. The guide spacer 100 is dimensioned to fit in the space 106 defined between the two side plates 44/46 when they are attached together, as shown in FIGS. 3-10, and to engage components of the hook plate 54 and lever arms 92/94, as shown in FIGS. 11-14.

In a preferred embodiment of the present invention, each of the lever arms 92/94 have a downward extending (i.e., toward the lower end 78 of the side plates 44/46) guide arm 105 toward the second end 98 of lever arm 92/94, as best shown in FIG. 12. The guide arms 105 are cooperatively sized and configured with the guide spacer 100 to help direct their respective lever arm 92/94 upward and downward in the space 106 between the connected side plates 44/46. In the embodiment shown in the figures, the guide arms 105 are disposed in a slight outwardly directed angle to compensate for the angle of the lever arms 92/94 as they pivot when pressed downward by the user to unlatch the gate latch 10.

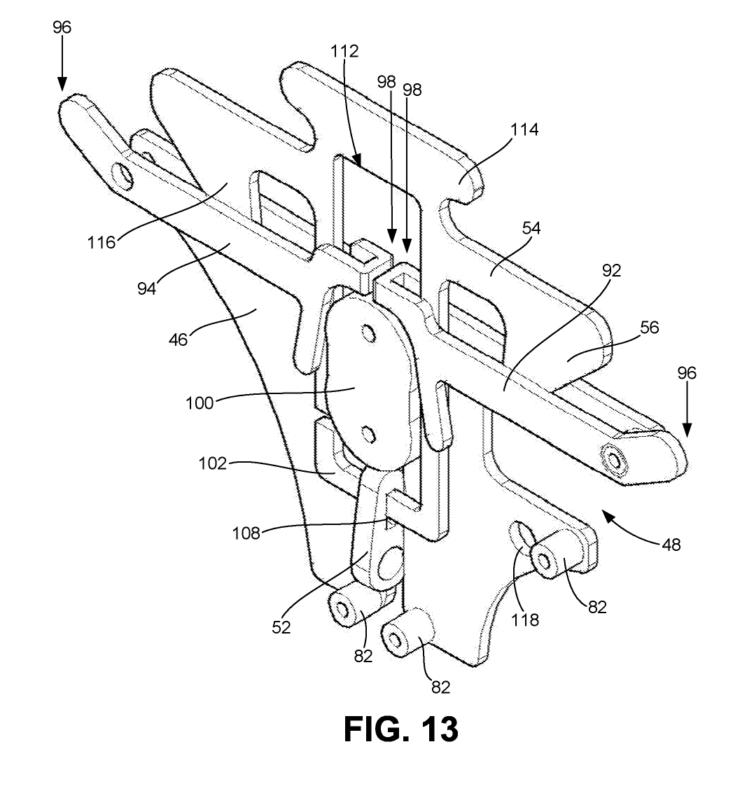

The latch hook 102 is utilized to draw the hook receiving member 52 upward in the space 106 along the slot 80 of the two side plates 44/46, as best shown in comparing FIGS. 11-12 to FIGS. 13-15, and to evenly raise the hook plate 54 when the user presses downward on the first end 96 of one of the lever arms 92/94 for smooth and easy operation of the gate latch 10 from either the front area 16 or back area 18 sides of the gate 14. The latch hook 102 is attached to or integral with the hook plate 54 so as to extend generally downward (i.e., toward the lower end 76 of the side plates 44/46) therefrom and sized and configured for a portion of the latch hook 102 to engage a slot 108 in the lock receiving member 52, best shown in FIGS. 13-15, so the receiving member 52 will move up and down with the latch hook 102, which itself moves up and down with the hook plate 54. As shown in these figures, the latch hook 102 has an opening 110 through which the receiving member 52 is inserted to hang from the latch hook 52 below the lower end 78 of the side plates 44/46 when the gate latch 10 is in its latched condition 60 with the strike member 38 in the latch mouth 48, behind hook member 56, or if the hook member 56 is closed so as to be in position to be contacted by the strike member 38 when the gate 14 is moved to its closed position 28.

The hook plate 54 and latch hook 102, which are preferably integrally formed, define a generally rectangular shaped engagement opening 112, best shown in FIGS. 13-15, that is engaged by the lever arms 92/94, the guide spacer 100 and the slot 108 in the lock receiving member 52. With regard to the lever arms 92/94, the second end 98 of each lever arm 92/94 is structured and arranged to contact the inside surface of the upper end of the engagement opening 112 to lift the hook plate 54, and therefore the hook member 56, upward when the first end 96 of the subject lever arm 92/94 is pushed downward by the user when he or she wants to pass through the gate 14 from either area 16/18. More specifically, when the user presses downward on the first end 96 of the first/front lever arm 92 (which he or she will do from the front area 16 side of the gate 14), the lever arm 92 will pivot the second end 98 thereof upward against the inside surface of the upper end of the engagement opening 112 to lift the hook plate 52 and hook member 54 upward so the strike member 38 may be removed from the latch mouth 48. When the user presses downward on the first end 96 of the second/back lever arm 94 (which he or she will do from the back area 18 side of the gate 14), the lever arm 94 will pivot the second end 98 thereof upward against the inside surface of the upper end of the engagement opening 112 to lift the hook plate 52 and hook member 54 upward so the strike member 38 may be removed from the latch mouth 48. In either direction, with the gate latch 10 in its unlatched condition 58, the user may then open the gate 14 and cross to the other area 16/18. With regard to the guide spacer 100, the guide spacer 100 engages the inside surfaces of the sides of the engagement opening 112 to evenly guide the hook plate 52 upward so the movement of the hook plate 54 and hook member 56 will be smooth and easy. With regard to the lock receiving member 52, when the hook plate 54 moves upward, as described above, it will engage the upper end of the slot 108 in the lock receiving member 52 and pull the lock receiving member 52 upward (if the shackle 70 of the padlock 66 is not in the aperture 68) along the slot 80 of the two side plates 44/46, as shown in FIGS. 13-15.

In the embodiment shown in the figures, the second end 98 of each of the first lever arm 92 and the second lever arm 94 are bent back to go around the latch hook 102 (i.e., towards the first end 96) to form a generally U-shaped second end 98, as shown in FIGS. 13-15. This configuration allows the latch hook 102 to move freely relative to the lever arms 92/94.

The above operation of the gate latch 10 to move the gate latch 10 to its unlatched condition 58 utilizes lever arms 92/94. In a preferred configuration of the gate latch 10 of the present invention, the gate latch 10 also has a pull plate 114 attached to or integral with the upper end of the hook plate 54 so as to extend above the upper end 76 of the side plates 44/46, as best shown in 5-15. In the embodiment shown in the figures, the pull plate 114 is integral with the hook plate 54, as best shown in FIGS. 6-8 and 13-15. The pull plate 114 is sized and configured to be grasped by the user and pulled upward (away from the upper end 76 of the side plates 44/46) to pull the hook member 56 out of the latch mouth 48 to place the gate latch 10 in its unlatched condition 58 so the strike member 38 can be removed from the latch mouth 48, as shown in FIGS. 6-8, and the gate 14 moved to its open position 30. With the gate latch 10 attached to the latch post 20 (or other first stationary object) and positioned in the gap 72 between the first/free end 24 of the gate 14 and the latch post 20, the user merely has to reach into the gap 72 and pull upward on the pull plate 114 to place the gate latch 10 in its unlatched condition 58 (with no padlock 66 in place).

In a preferred configuration of the gate latch 10 of the present invention, all of the components except the spacers 82 and the guide spacer 100 are made out of steel or other metal that is selected to be rigid and strong. To be substantially corrosion resistant, it is preferred that these components are painted, powder coated or otherwise treated. When manufacturing the components, they can be laser cut or formed by other processes well known in the relevant art. In one embodiment, the hook plate 54 also has a hook-shaped member 116 at the second/back side 90 of the gate latch 10, as best shown in FIGS. 11 and 12, to provide symmetry, balance and allow the hook plate 54 to be placed in the space 106 between the side plates 54/56 in either direction. When putting the gate latch 10 together, the guide spacer 100 is placed against the second/gate side plate 46 in a pair of small sized predrilled guide holes. The lock receiving member 52 is slid onto the latch hook 102 by inserting the slot 108 of the lock receiving member 52 through the opening 110 in the latch hook 102 and then directing it towards the bottom end of the latch hook 102. The latch hook 102, with the lock receiving member 52 at the bottom thereof, is placed onto the second/gate side plate 46 with the guide spacer 100 in the middle of the latch hook 102. This also positions the hook plate 54 in position with the hook member 56 at the latch mouth 48. Rivets or other plate connectors 84 are placed into the connector apertures 86 of the second side plate 46 and the spacers 82 are placed onto the rivets 84. The lower three spacers 82 can be cylindrically shaped. The upper two spacers 82, which are each associated with one of the lever arms 92/94, are sized and configured to be spacers/bearings to allow the lever arms 92/94 to pivot relative to the side plates 44/46. The bent second ends 98 of each of the lever arms 92/94 are placed on the latch hook 102 at the engagement opening 112 thereof and the lever arms 92/94 are engaged with their spacers 82 (which also serve as bearings). Once the components of the lever actuating mechanism 52 and the hook plate 54 are in position, the first/post side plate 44 is placed on the assembly, with the connector apertures 86 thereof aligned with the rivets 84 so the rivets 84 go through the first side plate 44 and then secure the rivets 84.

As set forth above, the gate latch 10 of the present invention is sized and configured to be attached to the first stationary object (i.e., latch post 20) and positioned laterally (i.e., from the first/front side 88 to the second/back side 90 of the gate latch 10) in the gap 72 between the first/free end 24 of the gate 14. The lock receiving member 52 is positioned on the gate latch 10 such that when the shackle 70 is received in the aperture 68, the padlock 66 will hang below the gate latch 10 in the gap 72, as can be readily understood by viewing FIGS. 1 and 10. As such, a person wanting to lock or unlock the gate 14 will be able to easily reach, rotate and manipulate the padlock 66, such as by using a key or operating a combination mechanism, to place the gate 14 in its unlocked condition 62 (i.e., no padlock 66) or its locked condition 64 (i.e., shackle 70 in the aperture of the lock receiving member 52). With the padlock 66 in place, the gate latch 10 cannot be moved to its unlatched condition 58, because the upper end of the shackle 70 will bump against the spacers 82 at the lower end 78 of the side plates 44/46 and prevent the hook plate 54 from moving upward enough for the hook member 56 to clear space for the strike member 38 to move out of the latch mouth 48. Although this is required for security (i.e., preventing unauthorized persons from passing through the gate 14), it can be difficult if an authorized person wants to pass through the gate 14 when the gate 14 is in its locked condition 64. Unlike other gravity gate latches, which allow access to the padlock 66 from only one side of the gate 14, the gate latch 10 of the present invention will allow a person to always be “on the right side” of the gate 14 with regard to being able to reach the padlock 66 for locking or unlocking the gate 14.

In the preferred embodiments of the gate latch 10 of the present invention, the gate latch 10 is provided with several features that enhance the effectiveness and use of the gate latch 10. One such feature is the addition of one or more padlock apertures 118 in the side plates 44/46 that is provided as a place to store the padlock 66 when it is not in use in the lock receiving member 52. As will be readily appreciated by persons who use gravity gate latches, once the padlock 66 is removed to unlock the gate 14 and the gate 14 is to remain unlocked, there is usually no convenient location to set down or otherwise place the padlock 66 until it is time to lock the gate 14. With the gate latch 10 of the present invention, the user can place the shackle 70 of the padlock 66 through the padlock apertures 118 and let the padlock 66 hang there until it is time to lock the gate 14. The padlock apertures 118 in the side plates 44/46 are positioned toward the first side 88 and/or the second side 90 of the gate latch 10 (shown generally toward the first side 88 in the figures). The padlock apertures 118 must be sized and configured to receive the shackle 70 of a typical padlock 66. In addition to providing a place to store the padlock 66, the padlock apertures 118 allow the user to leave the gate 14 unlocked (i.e., no padlock 66 in the lock receiving member 52), but provide an illusion that in fact the gate 14 is locked. For instance, from the front area 16 a person will see the padlock 66 in the padlock apertures 118 and, without detailed inspection, will assume that the locked padlock 66 hanging from the gate latch 10 is locking the gate 14 and will be unlikely to even approach the gate 14 in an attempt to gain unauthorized entry into the back area 18. The padlock aperture 118 feature will provide added security for the user.

Another feature preferably provided with the gate latch 10 of the present invention is that the hook member 56 is provided with an elongated edge 120, shown in FIG. 12, that provides greater tolerance for receiving the strike member 38 inside the latch mouth 48 of the gate latch 10. As well known in the art, many gates 14 of the type that are utilized with gate latch 10 have a tendency to sag, shift or otherwise move due to wood swelling, disrepair or improper build. The elongated edge 120 of the hook member 56, angling away from the first/front side 88 of the gate latch 10, provides increased tolerance for receiving the strike member 38 against the hook member 56 to receive the strike member 38 into the latch mouth 48 in case the gate 14 sags, shifts or otherwise moves.

In use, the user unlatches the gate latch 10 (when there is no padlock 66 in the lock receiving member 52) by pushing down on one of the two lever arms 92/94, depending on whether he or she is in the front area 16 or back area 18 side of the gate 14, or by pulling upward on the pull plate 114, which can be done from either side of the gate 14. The gate 14 is then free to swing to its open position 30. To latch the gate 14, the round section of the metal strike member 38 hits the angled face (i.e., the elongated edge 120) of the hook member 56, causing the hook plate 54 to lift upward and allow the strike member 38 to pass into the latch mouth 48. Once the strike member 38 has passed the bottom of the angled face 120 of the hook member 56 gravity causes the hook plate 54 to fall back into place, thereby capturing the strike member 38 in the latch mouth 48 behind the hook member 56 to securely place the gate 14 in its latched condition 58. At the bottom of the gate latch 10 (i.e., at the lower end 78 of the side plates 44/46) there is a unique tear-drop shaped lock receiving member 52, with an aperture 68 therein, that is attached to the latch hook 102. To place the gate 14 in its locked condition 64, the user inserts the shackle 70 of a padlock 66 through the aperture 68 of the lock receiving member 52 and locks the padlock 66. With the shackle 70 of the padlock 66 inserted into the aperture 68 of the lock receiving member 52, the latch hook 102 is not able to move sufficiently upward into the space 106 to allow the hook member 56 to move out of the latch mouth 48 due to the upper end of the shackle 70 contacting the two spacers 82 at the lower end 78 of the side plates 44/46, thereby maintaining the gate latch 10 in its locked condition 64 and unable to move to its unlatched condition 58. Because the gate latch 10 is mounted in the gap 72 between the first stationary object (i.e., latch post 20) and first/free end 24 of the swinging gate 14, the user can conveniently and easily rotate the padlock 66 to the side of the gate 14 (i.e., toward the front area 16 or back area 18) where he or she is standing to lock or unlock the padlock 66.

The unique design of the gravity gate latch 10 of the present invention allows it to be mounted in the gap 72 between the first stationary object 20 and the first/free end 24 of the gate 14. By placing the gate latch 10 between the first stationary object 20 and the gate 14, the gate latch 10 solves the problem of the inconvenience and difficulty of getting to the gate latch 10 or the padlock 66 when they are only readily accessible from one side of the gate 14. This unique design allows the user to securely and automatically latch and unlatch and easily and conveniently lock and unlock the gate latch 10 from either side of the gate 14. The lever arms 92/94, which extend beyond the outer edges of, respectively, the first side plate 44 and the second side plate 46, provide for easy opening from both sides of the gate 14. The large open latch mouth 48 and the longer elongated edge 120 of the hook member 56 allows the strike member 38 attached to the gate 14 to be more easily engaged and not jamb.

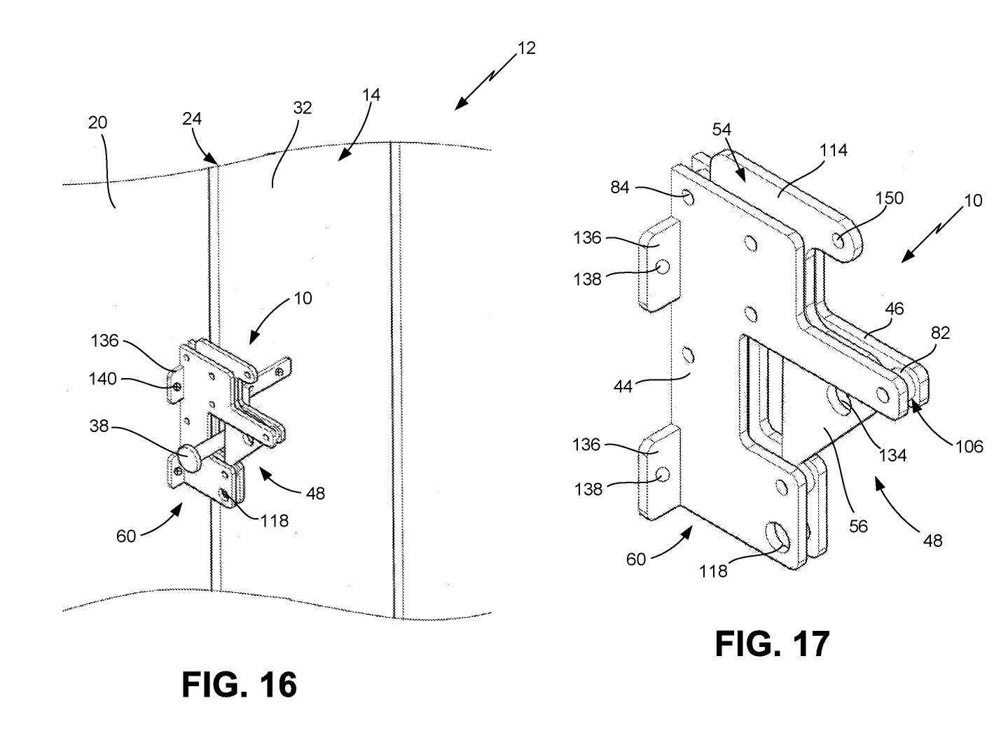

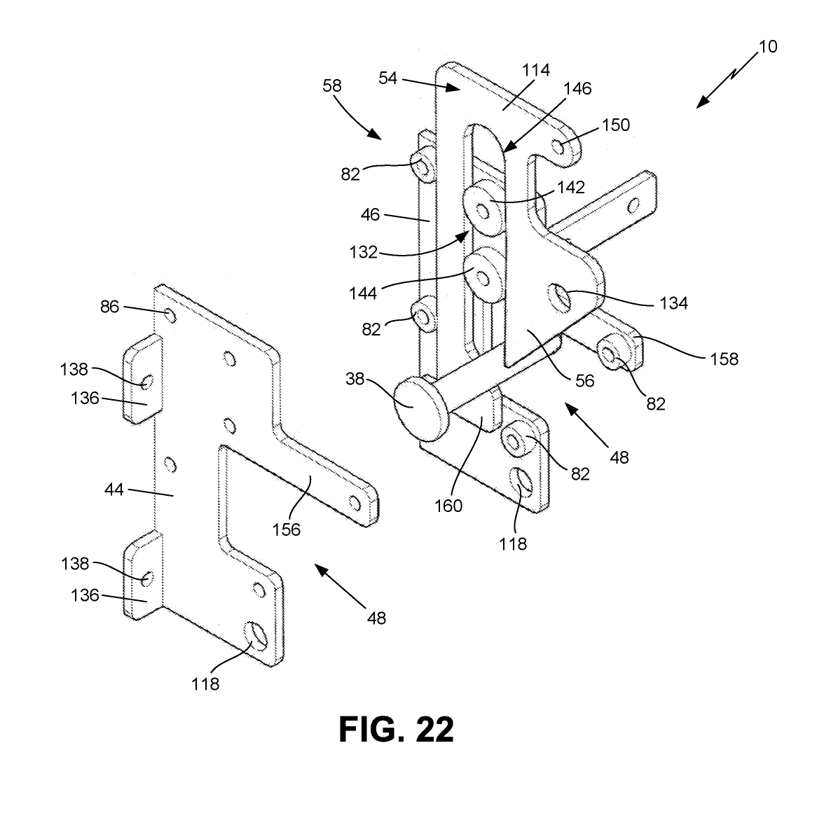

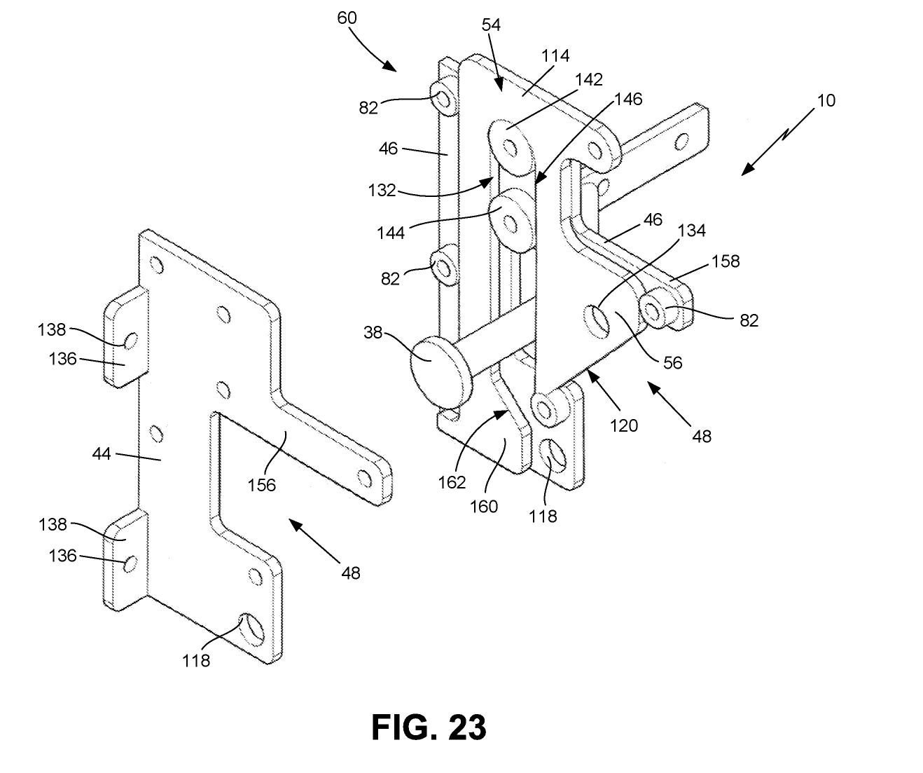

A second embodiment of the gravity gate latch, which is the present invention, is shown as 130 in FIGS. 16-25. The gravity gate latch 130 of the present embodiment, which can be utilized with gate system 132 shown in FIG. 16, utilizes many of the same components as described above for the first embodiment of the new gravity gate latch 10 shown in FIGS. 1-15. As described in more detail below, the gravity gate latch 130 of the present invention generally comprises a first side plate 44, a second side plate 46, a mouth 48 defined by the first plate 44 and second plate 46, a hook sliding mechanism 132 that is enclosed by the two plates 44/46, a hook plate 54 that is also enclosed by the two plates 44/46, a hook member 56, which is shown integrally formed with the hook plate 54, and a lock receiving aperture 132 in the hook member 56, as best shown in FIGS. 17-25. As set forth below, the hook plate 54 is shaped and configured to move along and be guided by the hook sliding mechanism 132, as best shown in FIGS. 22-25, to move the hook member 56 in a generally upward and downward direction. When the hook member 56 is up, as shown in FIGS. 18, 20 and 22, the gate latch 130 will be in its unlatched condition 58 and the strike member 38 will be able to move out of the mouth 48 (i.e., when moving to the open position 30 of gate 14). When the strike member 38 is in the mouth 48 and the hook member 56 is down, the hook member 56 closes the latch mouth 48 and traps the strike member 38 in the mouth 48 of the gate latch 130 to place the gate latch 130 in its latched condition 60 (the gate latch 130 is in its latched condition 60 with or without the strike member 38 in the mouth 48 of the gate latch 130) and, when the gate latch 130 is in use with the gate 14, places the gate 14 in its closed position 28, as best shown in FIG. 16. Normally, the gate latch 130 is in an unlocked condition 62 that allows the hook plate 54 to move upward along the sliding mechanism 132 in order to move the hook member 56 upward to receive the strike member 38 into the mouth 48 or to release the strike member 38 from the mouth 48. When the gate latch 130 is in its locked condition 64, with the lock 66 in the lock receiving aperture 134, the hook plate 54 will be unable to move the hook member 56 upward and downward and, in typical use, the strike member 38 will be trapped in the mouth 48 of gate latch 130, as shown in FIGS. 16, 19, 21 and 23-24. The lock receiving aperture 132 is sized and configured to receive a portion of a lock, such as the shackle 70 of a padlock 66, to place the gate latch 130 in its locked condition 64 and prevent the gate latch 130 from being placed in its unlatched condition 58.

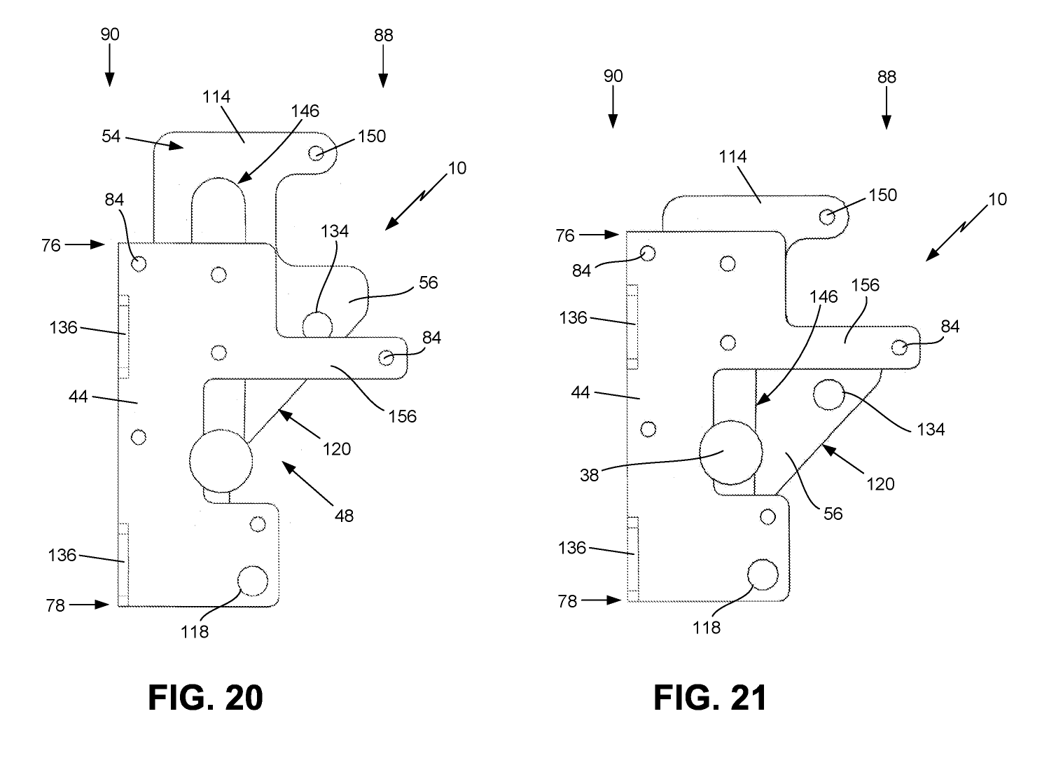

The gate latch 130 of the present invention is sized and configured to be attached to the latch post 20 in perpendicular relation to the strike member 38 and the first or free end 24 of the gate 14 (as opposed to being in the gap 72 as described above), as shown in FIG. 16. In one embodiment, each of the first side plate 44 and second side plate 46 have one or more perpendicularly positioned mounting tabs 136 that each have one or more mounting apertures 138, best shown in FIGS. 18-19 and 22-25, that are sized and configured to receive a connecting element 140 (shown in FIG. 16), such as a screw, bolt, nail or the like, that is selected to secure the gate latch 130 to the latch post 20 (or other type of first stationary object). In the embodiment shown in the figures, each side plate 44/46 has two mounting tabs 136 with one mounting aperture 138 each. Each of the side plates 44/46 have an upper end 76, above which the hook plate 54 moves along the sliding mechanism 134 when the gate latch 130 moves to its unlatched condition 58, and a lower end 78, as shown in FIGS. 20-21.

The two side plates 44/46 are disposed in spaced apart relation by a plurality of spacers 82 to define a space 106 therebetween for the hook plate 54 and sliding mechanism 132, as best shown in FIGS. 17 and 22-25. The two side plates 44/46 are joined together, with the spacers 82 therebetween to form the space 106, utilizing a plurality of plate connectors 84, which may be rivets, screws, bolts or other devices, that are received through connector apertures 86 in the two side plates 44/46, as best shown in FIGS. 22-25, and into the first stationary object (i.e., the latch post 20). As will be readily appreciated by persons who are skilled in the art, a variety of mechanisms and spacing elements can be utilized to attach the two side plates 44/46 together in spaced apart relation to each other.

The sliding mechanism 132, which is best shown in the partial exploded views in FIGS. 22-25, is structured and arranged to allow the hook plate 54 to quickly move upward when the hook member 56 is contacted from the first or front side 88 of the gate latch 130 (where the mouth 48 is located), by the strike member 38 as the gate 14 moves to its closed position 28 and to allow the user to manually place the gate latch 130 in its unlatched condition 58 when necessary or desired by the user. As best shown in FIGS. 20-21, the gate latch 130 has a second or back side 90, which is directed in an opposite direction from first/front side 88 so as to be generally disposed in the direction of the first stationary object 20 (i.e., latch post 20) to which the mounting tabs 136 are secured with the connecting elements 140, as shown in FIG. 16. The sliding mechanism 132 comprises one or more slide members, such as the pair of slide members identified as the first or upper slide member 142 and the second or lower slide member 144, secured to one of the side plates 44/46 (shown attached to second slide plate 46 in the figures) and a hook slot 146 in the hook plate 54, as best shown in FIGS. 22-25. The slide members 142/144 and hook slot 146 are cooperatively sized and configured to provide for substantially free upward/downward movement of the hook plate 54 relative to the slide members 142/144 and the slide plates 44/46 as the gate latch 130 moves between its latched condition 60, with the hook member 56 downwardly disposed (as shown in FIGS. 16-17, 19, 21 and 23-25), and its unlatched condition 62, with the hook member 56 generally upwardly disposed (as shown in FIGS. 18, 20 and 22) in between the two side plates 44/46.

In a preferred configuration of the gravity gate latch 130 of the present invention, the gate latch 130 also has a pull plate 114 that is attached to or integral with the upper end 148 of the hook plate 54 so as to extend above the upper end 76 of the side plates 44/46, as shown in FIGS. 16-25. In the embodiment shown in the figures, the pull plate 114 is integral with the hook plate 54. The pull plate 114 is sized and configured to be grasped by the user and pulled upward (away from the upper end 76 of the side plates 44/46) to pull the hook member 56 out of the latch mouth 48 to place the gate latch 130 in its unlatched condition 58 so the strike member 38 can be removed from the latch mouth 48, as shown in FIGS. 18, 20 and 22, and the gate 14 moved to its open position 30. With the gate latch 130 attached to the latch post 20 (or other first stationary object), the user merely has to pull upward on the pull plate 114 to place the gate latch 130 in its unlatched condition 58 (with no padlock 66 in place). To assist the user with placing the gate latch 130 in its unlatched condition 58 when he or she is on the opposite side of the gate 14 (i.e., typically the front area 16, with the mouth 48 of the gate latch 130 directed toward the back area 18), the pull plate 114 has a pull aperture 150 to which a string, wire or other elongated member (not shown) can be attached to lift the pull plate 114 upwards to place the gate latch 130 in its unlatched condition 58. The use of such elongated members to unlatch a gravity gate latch are well known by persons skilled in the art.

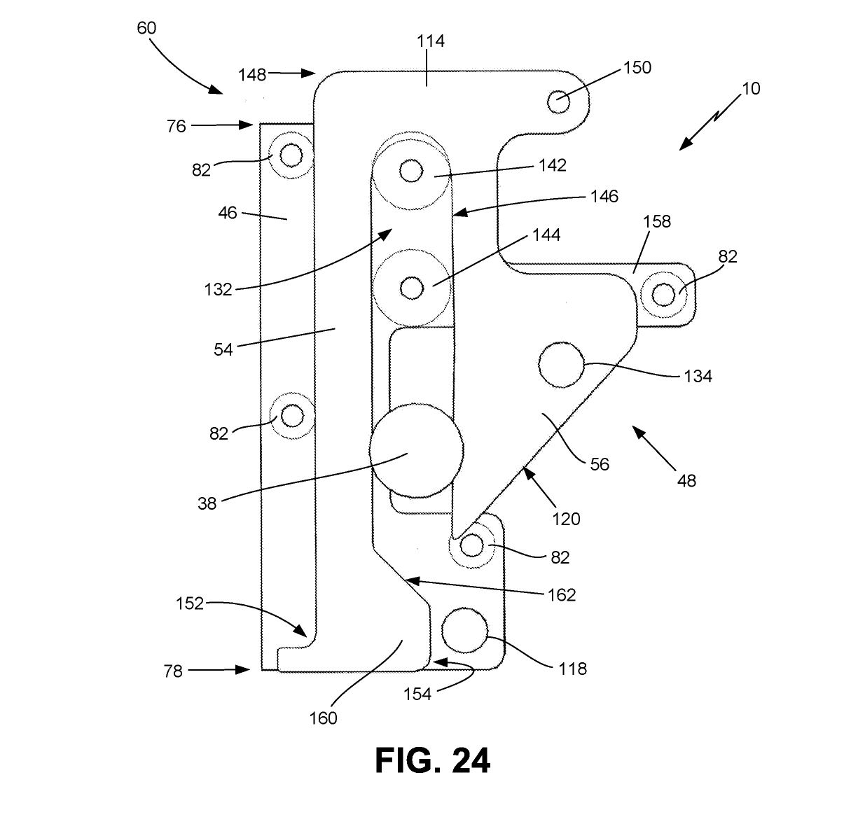

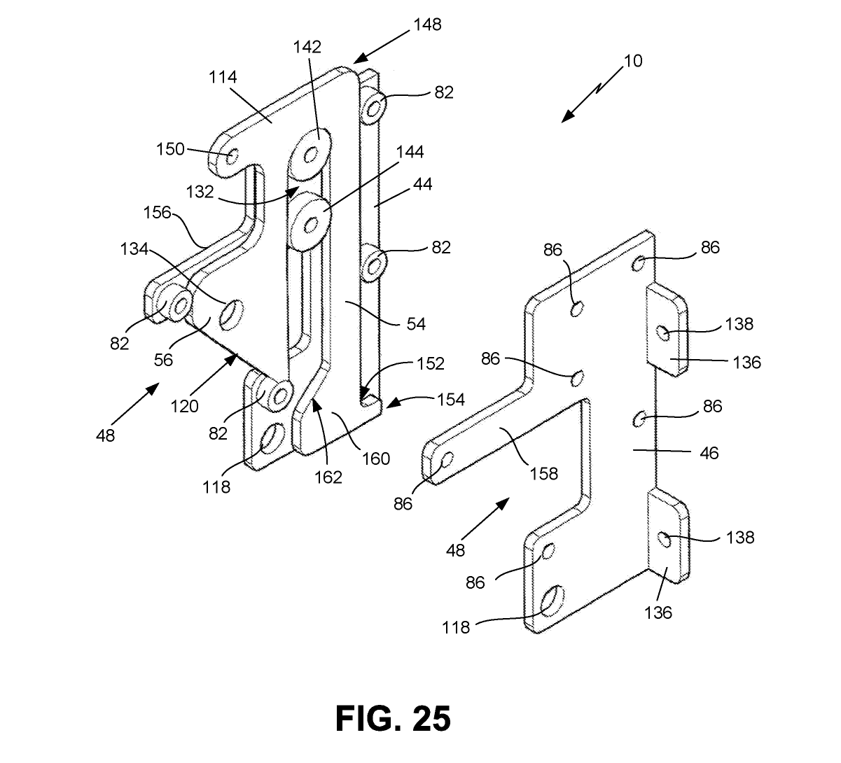

In a preferred configuration of the gate latch 130 of the present invention, all of the components except the spacers 82 are made out of a rigid and strong material, such as steel or other metals, composite materials or the like. To be substantially corrosion resistant, it is preferred that any steel components be painted, powder coated or otherwise treated (as known in the relevant art). When manufacturing the components, they can be laser cut or formed by other processes well known in the relevant art. In one embodiment, the hook plate 54 also has a hook-shaped area 152 at or near the lower end 154 thereof, as best shown in FIGS. 24-25, to prevent the hook plate 54 from being pulled completely out of the space 106 between the two side plates 44/46. When the pull plate 114 is pulled upward, the hook-shaped area 152 will contact the spacer 82 above it (located approximately midway between the upper end 76 and the lower end 78 of the side plates 44/46) to prevent any further upward movement of the pull plate 114 and, therefore, the hook plate 54.

As set forth above, the gate latch 130 of the present invention is sized and configured to be attached to the first stationary object (i.e., latch post 20) and positioned so the opening into the mouth 48 thereof is perpendicular to the strike member 38 when the free end 24 of the gate 14 is alongside the gate latch 130. Typically, the mouth 48 will be directed rearward into the back area 18 from the first stationary object 20. With the strike member 38 in the mouth 48 of the gate latch 130 and the padlock 66 in place in the lock receiving aperture 134, the gate latch 130 cannot be moved to its unlatched condition 58 because the upper end of the shackle 70 will bump against the two outward extending arms 156 and 158, best shown in FIGS. 20-25, that are attached to or integrally formed with, respectively, the first side plate 44 and the second side plate 46 so as to extend outwardly therefrom in the direction of the mouth 48 of the gate latch 130. Typically, the outwardly extending arms 156/158 will be integrally formed with the side plates 44/46. With the padlock 66 in place in the lock receiving aperture 134, the outward extending arms 156/158 of the side plates 44/46 prevent the hook plate 54 from moving upward enough for the hook member 56 to provide sufficient clearance for the strike member 38 to move out of the latch mouth 48, thereby keeping the gate latch 130 in its latched condition 60 and locked condition 64.

In the preferred embodiments of the gate latch 130 of the present invention, the gate latch 130 is provided with several features that enhance the effectiveness and use of the gate latch 130. One such feature is the addition of one or more padlock storage apertures 118 in the side plates 44/46 that is provided as a place to store the padlock 66 when it is not in use in the lock receiving member 52. As will be readily appreciated by persons who use gravity gate latches, once the padlock 66 is removed to unlock the gate 14 and the gate 14 is to remain unlocked, there is usually no convenient location to set down or otherwise place the padlock 66 until it is time to lock the gate 14. With the gate latch 130 of the present invention, the user can place the shackle 70 of the padlock 66 through the padlock apertures 118 and let the padlock 66 hang there until it is time to lock the gate 14. The padlock apertures 118 in the side plates 44/46 are aligned with each other and positioned toward the lower ends 78 thereof, as shown in FIGS. 16-25. The padlock storage apertures 118 must be sized and configured to receive the shackle 70 of a typical padlock 66.

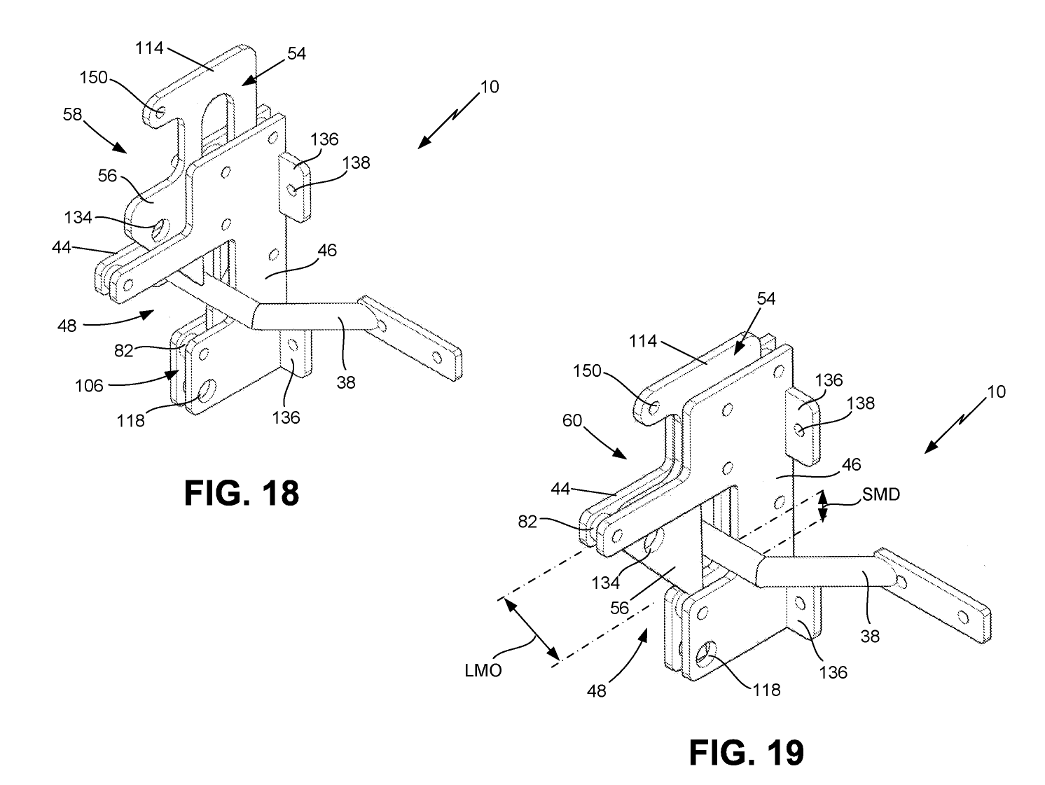

As shown in the figures with regard to the new gate latch 130, as well as with the above-described gate latch 10, the latch mouth 48 is enlarged relative to the diameter of the portion of the strike member 38 that is received in the latch mouth 48 of the gate latch 130. The enlarged opening of the latch mouth 48 is shown as latch mouth opening LMO and the relevant diameter (or width) of the strike member 48 is shown as strike member diameter SMD in FIG. 19. In a typical prior art gate latch, the latch mouth opening LMO is not that much larger than the strike member diameter SMD. In the preferred embodiments of the gate latch 130 of the present invention, the latch mouth opening LMO is significantly larger than the strike member diameter SMD. In one embodiment, the latch mouth opening LMO is at least three times the size of the strike member diameter SMD. The enlarged latch mouth opening LMO will allow more flexibility with regard to the initial positioning of the gate latch 130, particularly the latch mouth 48 thereof, and the strike member 38 (the relative relationship between the two components) and allow compensation for movement (i.e., sagging or the like) the gate 14 that, as described above, is known to occur.

Another feature preferably provided with the gate latch 130 of the present invention is that the hook member 56 is provided with an elongated edge 120, shown in FIGS. 20-21 and 23-25, that provides greater tolerance for receiving the strike member 38 inside the latch mouth 48 of the gate latch 130. As well known in the art, many gates 14 of the type that are utilized with gate latch 130 have a tendency to sag, shift or otherwise move due to wood swelling, disrepair or improper build. The elongated edge 120 of the hook member 56, angling away from the first/front side 88 of the gate latch 130 toward the second/back side 90 thereof, provides significantly increased tolerance (particularly when combined with the enlarged latch mouth opening LMO described above) for receiving the strike member 38 against the hook member 56, which is necessary to move the hook plate 54 upward to receive the strike member 38 through the latch mouth 48, in case the gate 14 sags, shifts or otherwise moves out of its original position.

Yet another advantageous feature of the gravity gate latch 130 of the present invention is that the hook plate 130 is provided with an enlarged area 160, having an angled edge 162, positioned toward the lower end 154 of the hook plate 54, as best shown in FIGS. 22-25. The enlarged area 160 and angled edge 162, which are positioned so as to jut out into the hook slot 146, are provided to more quickly drive down hook plate 54 when the hook plate 54 (at the enlarged area 160) is hit by the strike member 38. As described above in the Background, when a person slams or otherwise forcibly shuts the gate 14 when using a prior art gravity gate latch, the strike member 38 can hit the inside area of the mouth of the prior art gate latch so hard that the strike member 38 bounces out of the mouth prior to the hook member being able to capture the strike member in the mouth of the gate latch, which results in the gate 14 being unlatched. The new gravity gate latch 130 solves this problem by providing enlarged area 160 having the angled edge 162. As will be readily appreciated by persons who are skilled in the relevant art, when the strike member 38 moves into and through the mouth 48 and into the area of the hook slot 146, it will hit the angled edge 162 of the enlarged area 160 (after hitting and pushing up the hook member 56 to push the hook plate 54 upward and position the enlarged area 160 in the mouth 48 of the gate latch 130). The force of the strike member 38 against the angled edge 162 will drive the hook plate 54 downward, which will move the hook member 56 down in front of the strike member 38 and trap the strike member 38 in the hook slot 146 behind the mouth 48 of the gate latch 130. The harder the strike member 38 is moved against the angled edge 162 of the enlarged area 160 (such as by slamming the gate 14 shut), the more rapidly the hook plate 54 will move downward and drive the hook member 56 downward to effectively trap the strike member 38 in the hook slot 146 with the hook member 56 closing the latch mouth 48 of the gate latch 130 to prevent the problem of the strike member 38 bouncing out of the gate latch 130, a problem that is known to exist with prior art gravity gate latches.

In use, the gate latch 130 typically starts in its latched condition 60, meaning the strike member 38 is in the hook slot 146 rearward of hook member 56 that is positioned in the mouth 48 of the gate latch 130. The hook member 56 positioned in front of the strike member 38 prevents the strike member 38, and therefore the free end 24 of the gate 14, from moving away from the gate latch 130. To open the gate 14, the user moves the gate latch 130 to its unlatched condition 58 either by directly raising upward the pull plate 114 or using an elongated member to lift up the pull plate 114. Raising the pull plate 114 moves the hook plate 54 upward along the sliding mechanism 132 (i.e., the edges of the hook slot 146 move along the slide members 142/144) to move the hook member 56 upward and generally out of the mouth 48 of the gate latch 130 so the strike member 38 can be moved out of the mouth 48, typically by swinging the free end 24 of the gate 14 away from the gate latch 130. The hook plate 54 then drops downward by gravity, along the sliding mechanism 132, to place the gate latch 130 in its latched condition 60 with hook member 56 in the mouth 48 of the gate latch 130. When the gate 14 is closed and the strike member 38 is to be engaged by the gate latch 130, the strike member 38 will hit the elongated edge 120 of the hook member 56 and push the hook plate 54 and, as a result, the hook member 56 upward to allow the strike member 38 to move through the mouth 48 of the gate latch 130 and contact the angled edge 162 of the enlarged area 160. The movement of the hook slot 146 along the slide members 142/144 of the sliding mechanism 132 guides the hook plate 54 upward. Once the strike member 38 has moved through the mouth of the gate latch 130, into the area of the hook slot 146 and has hit the angled edge 162 of the enlarged area 160, the hook plate 54 drops downward (along the sliding mechanism 132) to move the hook member 56 back into the mouth 48 to trap the strike member 38 in the hook slot 146 behind the closed mouth 48 of the gate latch 130. If the gate 14 is slammed, causing the strike member 38 to hit hard against the angled edge 162 of the enlarged area 160, the force of the strike member 38 will more rapidly drive down the hook plate 54 and, therefore, the hook member 56 to quickly trap the strike member 38 behind the mouth 48 of the gate latch 130 (i.e., in the hook slot 146) to prevent the strike member 38 from bouncing out of the gate latch 130. The user then places the shackle 70 of the padlock 66 into the lock receiving aperture 134 to place the gate latch 130 in its locked condition 64. If someone attempts to place the gate latch 130 in its unlatched condition 58 by pulling upward on the pull plate 114 (directly or using an elongated member), the shackle 70 of the padlock 66 will hit the underside of the outward extending arms 156 of the side plates 44/46. This will prevent the gate latch 130 from being placed in its unlatched condition 58, thereby keeping the strike member 38 in the mouth 48 of the gate latch 130 and the gate 14 safely in its closed condition 28.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A gate latch for use with a gate having a strike member, said gate latch comprising:
a first side plate;
a second side plate attached to said first side plate in spaced apart relation to said first side plate so as to define a space therebetween, each of said first side plate and said second side plate configured to define a latch mouth at a first side of said gate latch, said latch mouth sized and configured to receive the strike member attached to or integral with a first end of the gate when the gate is in a closed condition;
a hook plate moveably disposed in said space between said first side plate and said second side plate, said hook plate having a hook member attached thereto or integral therewith, said hook plate disposing said hook member in said latch mouth so as to be contacted by the strike member when the gate is moved to the closed position; and
a sliding mechanism associated with each of said first side plate, said second side plate and said hook plate, said sliding mechanism disposed in said space between said first side plate and said second side plate and structured and arranged to allow said gate latch to move between a latched condition with said hook member positioned in said latch mouth substantially closing said latch mouth and an unlatched condition with said hook member positioned sufficiently above said latch mouth to allow the strike member to move out of or into said latch mouth,
wherein said gate latch is sized and configured to be attached to a stationary object with said first side of said gate latch positioned to receive the strike member in said hook slot behind said latch mouth to trap said strike member therein by said hook member so as to place said gate latch in said latched condition and to raise said hook plate to place said gate latch in an unlatched condition.

2. The gate latch of claim 1 further comprising a pull plate attached to or integral with said hook plate so as to extend above an upper end of each of said first side plate and said second side plate, said pull plate sized and configured to be pulled upward and pull said hook plate and hook member upward so as to move said gate latch from said latched condition to said unlatched condition.

3. The gate latch of claim 1 further comprising a lock receiving aperture in said hook member that is sized and configured to receive a shackle of a padlock, said lock receiving aperture positioned so as to place said gate latch in a locked condition that prevents upward movement of said hook plate sufficient to move said hook member to said unlatched condition, thereby securing said gate latch in said latched condition.

4. The gate latch of claim 3, wherein at least one of said first side plate and said second side plate comprise an outward extending arm that is positioned generally above said lock receiving aperture when said gate latch is in said locked condition, said outward extending arm structured and arranged to be engaged by the shackle of the padlock so as to prevent said gate latch being placed in said unlatched condition.

5. The gate latch of claim 4, wherein said first side plate has a first outwardly extending arm and said second side plate has a second outwardly extending arm in spaced apart relation to said first outward extending arm, said hook member sized and configured to move upwardly and downwardly between said first outwardly extending arm and said second outwardly extending arm when moving between said latched condition and said unlatched condition.

6. The gate latch of claim 1 further comprising a padlock aperture in at least one of said first side plate and said second side plate, said padlock aperture sized and configured to receive a shackle of a padlock without engaging said hook plate or said sliding mechanism so as to store said padlock on said gate latch without placing said gate latch in a locked condition.

7. The gate latch of claim 1, wherein said hook plate has an enlarged area with an angled edge, said enlarged area shaped and configured to be hit by the strike member and rapidly lower said hook plate and trap the strike member in said hook slot of said hook plate generally behind said latch mouth with said hook member in said latch mouth to place said gate latch in said latched condition.

8. The gate latch of claim 1 further comprising one or more spacers disposed between said first side plate and said second side plate, said spacers sized and configured to position said second side plate in spaced apart relation to said first side plate and define said space therebetween.

9. The gate latch of claim 1, wherein said hook member has an elongated edge disposed in said latch mouth so as to be contacted by the strike member when said gate latch is engaged by the strike member to place said gate latch in said latched condition.

10. The gate latch of claim 1, wherein said hook member has a hook-shaped area that is sized and configured to engage a spacer disposed between said first side plate and said second side plate so as to prevent said hook plate from exiting above an upper end of each of said first side plate and said second side plate.

11. The gate latch of claim 1, wherein said latch mouth has an enlarged latch mouth opening that is at least three times larger than the strike member diameter of the strike member.

12. A gate latch for use with a gate having a strike member, said gate latch comprising:
a first side plate;
a second side plate attached to said first side plate in spaced apart relation to said first side plate so as to define a space therebetween, each of said first side plate and said second side plate configured to define a latch mouth at a first side of said gate latch, said latch mouth sized and configured to receive the strike member attached to or integral with a first end of the gate when the gate is in a closed condition;
a hook plate moveably disposed in said space between said first side plate and said second side plate, said hook plate having a hook member attached thereto or integral therewith, said hook plate disposing said hook member in said latch mouth so as to be contacted by the strike member when the gate is moved to the closed position;
a pull plate attached to or integral with an upper end of said hook plate so as to move said hook plate upward and said hook member generally above said latch mouth;
a sliding mechanism associated with each of said first side plate, said second side plate and said hook plate, said sliding mechanism disposed in said space between said first side plate and said second side plate and structured and arranged to allow said gate latch to move between a latched condition with said hook member positioned in said latch mouth substantially closing said latch mouth and an unlatched condition with said hook member positioned sufficiently above said latch mouth to allow the strike member to move out of or into said latch mouth; and
a lock receiving aperture in said hook member that is sized and configured to receive a shackle of a padlock, said lock receiving aperture positioned so as to place said gate latch in a locked condition that prevents upward movement of said hook plate sufficient to move said hook member to said unlatched condition, thereby securing said gate latch in said latched condition,
wherein said gate latch is sized and configured to be attached to a stationary object with said first side of said gate latch positioned to receive the strike member in said hook slot behind said latch mouth to trap said strike member therein by said hook member so as to place said gate latch in said latched condition and to raise said hook plate with said pull plate to place said gate latch in an unlatched condition.

13. The gate latch of claim 12, wherein at least one of said first side plate and said second side plate comprise an outward extending arm that is positioned generally above said lock receiving aperture when said gate latch is in said locked condition, said outward extending arm structured and arranged to be engaged by the shackle of the padlock so as to prevent said gate latch being placed in said unlatched condition.

14. The gate latch of claim 13, wherein said first side plate has a first outwardly extending arm and said second side plate has a second outwardly extending arm in spaced apart relation to said first outward extending arm, said hook member sized and configured to move upwardly and downwardly between said first outwardly extending arm and said second outwardly extending arm when moving between said latched condition and said unlatched condition.

15. The gate latch of claim 12, wherein said hook plate has an enlarged area with an angled edge, said enlarged area shaped and configured to be hit by the strike member and rapidly lower said hook plate and trap the strike member in said hook slot of said hook plate generally behind said latch mouth with said hook member in said latch mouth to place said gate latch in said latched condition.

16. The gate latch of claim 12, wherein said hook member has an elongated edge disposed in said latch mouth so as to be contacted by the strike member when said gate latch is engaged by the strike member to place said gate latch in said latched condition.

17. The gate latch of claim 12, wherein said hook member has a hook-shaped area that is sized and configured to engage a spacer disposed between said first side plate and said second side plate so as to prevent said hook plate from exiting above an upper end of each of said first side plate and said second side plate.

18. The gate latch of claim 12, wherein said latch mouth has an enlarged latch mouth opening that is at least three times larger than the strike member diameter of the strike member.

19. A gate latch for use with a gate having a strike member, said gate latch comprising:
a first side plate;
a second side plate attached to said first side plate in spaced apart relation to said first side plate so as to define a space therebetween, each of said first side plate and said second side plate configured to define a latch mouth at a first side of said gate latch, said latch mouth sized and configured to receive the strike member attached to or integral with a first end of the gate when the gate is in a closed condition, said latch mouth having an enlarged latch mouth opening that is at least three times larger than the strike member diameter of the strike member;
a hook plate moveably disposed in said space between said first side plate and said second side plate, said hook plate having a hook member attached thereto or integral therewith, said hook plate disposing said hook member in said latch mouth so as to be contacted by the strike member when the gate is moved to the closed position, said hook member having an elongated edge disposed in said latch mouth so as to be contacted by the strike member when said gate latch is engaged by the strike member;
a pull plate attached to or integral with an upper end of said hook plate so as to move said hook plate upward and said hook member generally above said latch mouth;
a sliding mechanism associated with each of said first side plate, said second side plate and said hook plate, said sliding mechanism disposed in said space between said first side plate and said second side plate and structured and arranged to allow said gate latch to move between a latched condition with said hook member positioned in said latch mouth substantially closing said latch mouth and an unlatched condition with said hook member positioned sufficiently above said latch mouth to allow the strike member to move out of or into said latch mouth; and
a lock receiving aperture in said hook member that is sized and configured to receive a shackle of a padlock, said lock receiving aperture positioned so as to place said gate latch in a locked condition that prevents upward movement of said hook plate sufficient to move said hook member to said unlatched condition, thereby securing said gate latch in said latched condition,
wherein said gate latch is sized and configured to be attached to a stationary object with said first side of said gate latch positioned to receive the strike member in said hook slot behind said latch mouth to trap said strike member therein by said hook member so as to place said gate latch in said latched condition and to raise said hook plate with said pull plate to place said gate latch in an unlatched condition.

20. The gate latch of claim 19, wherein said hook plate has an enlarged area with an angled edge, said enlarged area shaped and configured to be hit by the strike member and rapidly lower said hook plate and trap the strike member in said hook slot of said hook plate generally behind said latch mouth with said hook member in said latch mouth to place said gate latch in said latched condition.
